(19) United States
(12) Patent Application Publication
(10) Pub. No.: US 2026/0001143 A1
(43) Pub. Date: Jan. 1, 2026

(54) COATED CUTTING TOOL

(71) Applicant: TUNGALOY CORPORATION, Fukushima (JP)

(72) Inventors: Cangyu FAN, Iwaki-shi (JP); Tsukasa SHIROCHI, Iwaki-shi (JP)

(73) Assignee: TUNGALOY CORPORATION, Fukushima (JP)

(21) Appl. No.: 19/229,931

(22) Filed: Jun. 5, 2025

(30) Foreign Application Priority Data
Jun. 27, 2024 (JP) 2024-103830

(51) Int. Cl. B23B 27/14

(52) U.S. Cl. CPC B23B 27/148; B23B 2228/105

(57) ABSTRACT

A coated cutting tool comprising a substrate and a coating layer formed on a surface of the substrate, wherein the coating layer comprises a lower layer, an intermediate layer, and an upper layer, the lower layer comprises a specific Ti compound layer, the intermediate layer comprises an α-Al₂O₃ layer, the upper layer comprises a TiCN layer, an average thickness of the entire coating layer is 8.5 μm or more and 30.0 μm or less, an average thickness of the upper layer is 1.0 μm or more and 6.0 μm or less, an average diameter of the specific regions is 0 degrees or more and less than 15 degrees is less than 5.0 μm in the TiCN layer of the upper layer, and 30≤RSA≤70 and 20≤RSB≤60 are satisfied in the TiCN layer of the upper layer.

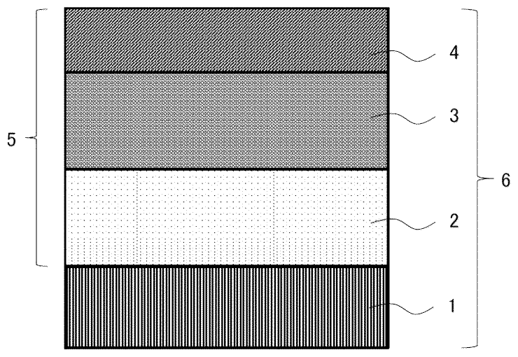

### TECHNICAL FIELD

The present invention relates to a coated cutting tool.

### BACKGROUND ART

It is well known that a conventional coated cutting tool used for the cutting of steel, cast iron, etc., is a coated cutting tool which is obtained by depositing, via chemical vapor deposition, a coating layer with a total thickness of from 3 μm or more to 20 μm or less on a surface of a substrate consisting of a cemented carbide. A known example of the above coating layer is a coating layer consisting of a single layer of one kind selected from the group consisting of a Ti carbide, a Ti nitride, a Ti carbonitride, a Ti carboxide, a Ti oxycarbonitride, and aluminum oxide (Al₂O₃), or consisting of multiple layers of two or more kinds selected therefrom.

For example, Japanese Patent Laid-Open No. 2014-188626 describes a surface coated member including a coating layer consisting of multilayers containing at least one TiCN layer on a surface of a base, wherein an upper layer TiCN layer located as the uppermost layer in the TiCN layer consists of a TiCN granular crystal, and a (422) peak is strongest in an X-ray diffraction measurement.

In addition, for example, WO 2000/079022 A describes a coated hard alloy including a coating layer on a hard alloy surface, wherein the coating layer includes an inner layer, an intermediate layer, and an outer layer in an order from a hard alloy side; the inner layer includes one or more layers selected from carbides, nitrides, borides, and oxides of IVa, Va, and VIa groups in a periodic table, and solid solutions thereof; the intermediate layer includes one or more layers selected from aluminum oxide, zirconium oxide, and solid solutions thereof; the outer layer includes one or more layers selected from carbides, nitrides, borides, and oxides of IVa, Va, and VIa groups in a periodic table, and solid solutions thereof, and aluminum oxide, the one or more layers including a titanium carbonitride layer having a columnar structure; and a relationship between a maximum roughness Amax of a surface layer part of the intermediate layer in a cross-sectional structure of the coated hard alloy and a maximum roughness Bmax of a surface layer part of the titanium carbonitride layer having a columnar structure in the outer layer satisfies a formula 1:

$$( B max / A max ) < 1 \qquad Formula 1$$

provided that 0.5 μm<Amax<4.5 μm, and 0.5 μm≤Bmax≤4.5 μm.

In addition, WO 2000/079022 A describes a relationship between a maximum roughness value Amax of the surface layer part of the intermediate layer in the cross-sectional structure of the coated hard alloy and a roughness Bmax of the surface layer part of the titanium carbonitride layer having a columnar structure in the outer layer satisfies a formula 2:

$$( B max / A max ) < 0.8 \qquad Formula 2$$

WO 2000/079022 A also describes that the orientation index TC shown in the formula 3 of the titanium carbonitride layer having a columnar structure in the outer layer is the largest in any of a (220) plane, a (311) plane, a (331) plane, and a (422) plane, and the maximum value thereof is 1.3 or more and 3.5 or less:

$$TC ( hkl ) = \frac{I ( hkl )}{Io ( hkl )} {\{ \frac{1}{8} {\sum }_{x , y , z} \frac{I ( h , k , l . )}{Io ( h , k , l . )} \}}^{- 1} \qquad Formula 3$$

wherein
I(hkl) and I(hₓk_{y}l_{z}) are diffraction intensities of measured (hkl) or (hₓk_{y}l_{z}) planes, Io(hkl) and Io(hₓk_{y}l_{z}) are average values of powder diffraction intensities of TiC and TiN on (hkl) or (hₓk_{y}l_{z}) planes by ASTM Standard, and (hkl) and (hₓk_{y}l_{z}) are 8 planes of (111), (200), (220), (311), (331), (420), (422), and (511).

### SUMMARY

### Technical Problem

An increase in speed, feed and depth of cut has become more conspicuous in cutting in recent times, and the wear resistance, the chipping resistance and the fracture resistance of a tool are required to be further improved compared to those involved in the prior art. In particular, in recent years, there has been an increase in the number of cutting operations in which a load is applied to a coated cutting tool, such as high-speed cutting of steel, and under such severe cutting conditions, the wear resistance, the chipping resistance and the fracture resistance are not sufficient in the conventional tools, which makes it impossible to extend the tool life. In the surface coated member described in Japanese Patent Laid-Open No. 2014-188626, the upper layer TiCN layer located as the uppermost layer in the coating layer is the TiCN layer having the strongest (422) peak, so that the wear resistance is excellent, but grains are easily falling off, and thus there is room for improvement in chipping resistance and fracture resistance. In addition, in the coated hard alloy described in WO 2000/079022 A, the dispersion state of grains oriented to a (220) plane of the TiCN layer (titanium carbonitride layer) in the outer layer is not considered, and thus there is room for improvement in wear resistance, chipping resistance and fracture resistance.

The present invention has been made in light of the above circumstances, and an object of the present invention is to provide a coated cutting tool which has excellent wear resistance, chipping resistance and fracture resistance and which accordingly allows for an extended tool life.

### Solution to Problem

The inventors of the present invention have conducted research on extending the tool life of a coated cutting tool from the above perspective. It has been found that, with a specific configuration, the wear resistance, the chipping resistance and the fracture resistance can be improved, and as a result, the tool life can be extended. The present invention has been accomplished based on this finding.

Thus, the present invention is as follows.

[1] A coated cutting tool comprising a substrate and a coating layer formed on a surface of the substrate, wherein:
the coating layer comprises a lower layer, an intermediate layer, and an upper layer in this order from the substrate side to the surface side of the coating layer;
the lower layer comprises a Ti compound layer containing a Ti compound of Ti and an element of at least one kind selected from the group consisting of C, N, O and B;
the intermediate layer comprises an α-Al₂O₃ layer containing α-aluminum oxide;
the upper layer comprises a TiCN layer containing a Ti carbonitride;
an average thickness of the entire coating layer is 8.5 μm or more and 30.0 μm or less;
an average thickness of the upper layer is 1.0 μm or more and 6.0 μm or less;
the TiCN layer of the upper layer satisfies conditions represented by following formula (i) and formula (ii):

$$30 \leq RSA \leq 70 \qquad ( i )$$

in the formula (i), where, in a cross section of the TiCN layer of the upper layer in a direction parallel to the surface of the substrate, a sum of areas of an entire cross section is taken as 100 area %, RSA is a ratio, in terms of area %, of a sum of cross-sectional areas of regions A where a misorientation A is 0 degrees or more and less than 15 degrees, the misorientation A being an angle, in terms of degrees, formed by a normal to the cross section of the TiCN layer and a normal to a (422) plane of grains of the TiCN layer;

$$20 \leq RSB \leq 60 \qquad ( ii )$$

in the formula (ii), where, in a cross section of the TiCN layer of the upper layer in a direction parallel to the surface of the substrate, a sum of areas of an entire cross section is taken as 100 area %, RSB is a ratio, in terms of area %, of a sum of cross-sectional areas of regions B where a misorientation B is 0 degrees or more and less than 15 degrees, the misorientation B being an angle, in terms of degrees, formed by a normal to the cross section of the TiCN layer and a normal to a (220) plane of grains of the TiCN layer; and
an average diameter of the region B is less than 5.0 μm in the TiCN layer of the upper layer.

[2] The coated cutting tool according to [1], wherein the average diameter of the region B is 1.0 μm or more in the TiCN layer of the upper layer.

[3] The coated cutting tool according to [1] or [2], wherein an average diameter of the region A is 5.0 μm or more and 30.0 μm or less in the TiCN layer of the upper layer.

[4] The coated cutting tool according to any one of [1] to [3], wherein an average grain diameter of grains is 0.3 μm or more and 1.2 μm or less in the TICN layer of the upper layer.

[5] The coated cutting tool according to any one of [1] to [4], wherein a texture coefficient TC (0,0,12) of a (0,0,12) plane of the α-Al₂O₃ layer represented by a following formula (iii):

$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$

wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

[6] The coated cutting tool according to any one of [1] to [5], wherein an average thickness of the intermediate layer is 3.0 μm or more and 15.0 μm or less.

[7] The coated cutting tool according to any one of [1] to [6], wherein an average thickness of the lower layer is 3.0 μm or more and 15.0 μm or less.

[8] The coated cutting tool according to any one of [1] to [7], wherein the substrate is any one of a cemented carbide, cermet, ceramic or a cubic boron nitride sintered body.

### Advantageous Effects of Invention

The coated cutting tool of the present invention can extend the tool life by having excellent wear resistance, chipping resistance and fracture resistance.

### BRIEF DESCRIPTION OF DRAWINGS

The FIGURE is a schematic cross-sectional view showing an example of a coated cutting tool according to the present invention.

### DESCRIPTION OF EMBODIMENTS

An embodiment for carrying out the present invention (hereinafter simply referred to as the “present embodiment”) will hereinafter be described in detail, with reference to the attached drawings as appropriate. However, the present invention is not limited to the present embodiment below. Various modifications may be made to the present invention without departing from the gist of the invention. In the drawings, unless otherwise specified, positional relationships, such as vertical and horizontal relationships, are based on the positional relationships shown in the drawings. Further, the dimensional ratios of the drawings are not limited to those shown therein.

The coated cutting tool of the present embodiment is a coated cutting tool including a substrate and a coating layer formed on a surface of the substrate. The coating layer includes a lower layer, an intermediate layer, and an upper layer in this order from the substrate side to the surface side of the coating layer. The lower layer includes a Ti compound layer containing a Ti compound of Ti and an element of at least one kind selected from the group consisting of C, N, O and B. The intermediate layer includes an α-Al₂O₃ layer containing α-aluminum oxide. The upper layer includes a TiCN layer containing a Ti carbonitride. An average thickness of the entire coating layer is 8.5 μm or more and 30.0 μm or less. An average thickness of the upper layer is 1.0 μm or more and 6.0 μm or less. The TiCN layer of the upper layer satisfies conditions represented by following formula (i) and formula (ii):

$$30 \leq RSA \leq 70 \qquad ( i )$$

in the formula (i), where, in a cross section of the TiCN layer of the upper layer in a direction parallel to the surface of the substrate, a sum of areas of an entire cross section is taken as 100 area %, RSA is a ratio, in terms of area %, of a sum of cross-sectional areas of regions A where a misorientation A is 0 degrees or more and less than 15 degrees, the misorientation A being an angle, in terms of degrees, formed by a normal to the cross section of the TiCN layer and a normal to a (422) plane of grains of the TiCN layer; and

$$20 \leq RSB \leq 60 \qquad ( ii )$$

in the formula (ii), where, in a cross section of the TiCN layer of the upper layer in a direction parallel to the surface of the substrate, a sum of areas of an entire cross section is taken as 100 area %, RSB is a ratio, in terms of area %, of a sum of cross-sectional areas of regions B where a misorientation B is 0 degrees or more and less than 15 degrees, the misorientation B being an angle, in terms of degrees, formed by a normal to the cross section of the TiCN layer and a normal to a (220) plane of grains of the TiCN layer. An average diameter of the region B is less than 5.0 μm in the TiCN layer of the upper layer.

The coated cutting tool of the present embodiment comprises the above-described configurations, and this allows the wear resistance, the chipping resistance and the fracture resistance of the coated cutting tool to be improved; as a result, the tool life thereof can be extended. The factors for the improvements in wear resistance, chipping resistance and fracture resistance of the coated cutting tool of the present embodiment can be considered to be set forth as follows. However, the present invention is not in any way limited by the factors set forth below. In other words, firstly, the coated cutting tool of the present embodiment contains a Ti compound layer containing a Ti compound of Ti and an element of at least one kind selected from the group consisting of C, N, O and B as the lower layer of the coating layer. When the coated cutting tool of the present embodiment includes such a lower layer between the substrate and the intermediate layer including the α-Al₂O₃ layer containing α-aluminum oxide, the wear resistance and adhesion are improved. In the coated cutting tool of the present embodiment, since the upper layer includes the TiCN layer containing a Ti carbonitride, the hardness is high, so that the wear resistance is improved. In the coated cutting tool of the present embodiment, since the average thickness of the entire coating layer is 8.5 μm or more, the wear resistance is excellent. Meanwhile, in the coated cutting tool of the present embodiment, since the average thickness of the entire coating layer is 30.0 μm or less, the adhesion of the coating layer is improved, so that the chipping resistance and the fracture resistance are excellent. In the coated cutting tool of the present embodiment, since the average thickness of the upper layer is 1.0 μm or more, the wear resistance is excellent. Meanwhile, in the coated cutting tool of the present embodiment, since the average thickness of the upper layer is 6.0 μm or less, the adhesion of the coating layer is improved, so that the chipping resistance and the fracture resistance are excellent. In the coated cutting tool of the present embodiment, since the RSA is 30 area % or more, the wear resistance is excellent. Meanwhile, in the coated cutting tool of the present embodiment, since the RSA is 70 area % or less, grains are prevented from falling off, so that the chipping resistance and the fracture resistance are excellent. In the coated cutting tool of the present embodiment, since the RSB is 20 area % or more, grains are prevented from falling off, so that the chipping resistance and the fracture resistance are excellent. Meanwhile, in the coated cutting tool of the present embodiment, since the RSB is 60 area % or less, the wear resistance is excellent. In the coated cutting tool of the present embodiment, the average diameter of the region B being less than 5.0 μm in the TiCN layer of the upper layer indicates that regions B are dispersedly formed in the TiCN layer, allows the effect of preventing grains from falling off by having the above RSB of 20 area % or more to be effectively and reliably provided, and reduces coarse regions B, so that the wear resistance is improved. The combining of the above configurations allows for the coated cutting tool of the present embodiment to have improved wear resistance, chipping resistance and fracture resistance, and accordingly, it can be considered that the tool life can be extended.

The FIGURE is a schematic cross-sectional view showing an example of the coated cutting tool of the present embodiment. A coated cutting tool 6 is provided with a substrate 1 and a coating layer 5 located on a surface of the substrate 1, and a lower layer 2, an intermediate layer 3 and an upper layer 4 are laminated in this order from the substrate side in an upward direction in the coating layer 5.

The coated cutting tool according to the present embodiment comprises a substrate and a coating layer formed on a surface of the substrate. Specific examples of types of the coated cutting tool include an indexable cutting insert for milling or turning, a drill and an end mill.

The substrate used in the present embodiment is not particularly limited, as long as it may be used as a substrate for a coated cutting tool. Examples of such substrate include a cemented carbide, cermet, ceramic, a cubic boron nitride sintered body, a diamond sintered body and high-speed steel. From among the above examples, the substrate is preferably comprised of a cemented carbide, cermet, ceramic or a cubic boron nitride sintered body as this provides further excellent wear resistance and fracture resistance, and, from the same perspective, the substrate is more preferably comprised of a cemented carbide.

It should be noted that the surface of the substrate may be modified. For instance, when the substrate is comprised of a cemented carbide, a β-free layer may be formed on the surface thereof, and when the substrate is comprised of cermet, a hardened layer may be formed on the surface thereof. The operation and effects of the present invention are still provided even if the substrate surface has been modified in this way.

The average thickness of the entire coating layer used in the present embodiment is preferably 8.5 μm or more and 30.0 μm or less. In the coated cutting tool of the present embodiment, since the average thickness of the entire coating layer is 8.5 μm or more, the wear resistance is excellent. Meanwhile, in the coated cutting tool of the present embodiment, since the average thickness of the entire coating layer is 30.0 μm or less, the adhesion of the coating layer is improved, so that the chipping resistance and the fracture resistance are excellent. From the same viewpoint, the average thickness of the entire coating layer is preferably 11.3 μm or more and 28.1 μm or less, and more preferably 13.5 μm or more and 25.1 μm or less.

It should be noted that, as to the average thickness of each layer and the average thickness of the entire coating layer in the coated cutting tool of the present embodiment, each of such average thicknesses can be obtained by: measuring the thickness of each layer or the thickness of the entire coating layer from each of the cross-sectional surfaces at three or more locations in each layer or in the entire coating layer; and then calculating the arithmetic mean of the resulting measurements.

### Lower Layer

The lower layer used in the present embodiment includes a Ti compound layer composed of a Ti compound of Ti and an element of at least one kind selected from the group consisting of C, N, O and B. When the coated cutting tool of the present embodiment includes such a lower layer between the substrate and the intermediate layer including the α-Al₂O₃ layer containing α-aluminum oxide, the wear resistance and adhesion are improved.

The Ti compound layer in the lower layer is not particularly limited, and examples thereof include a TiC layer containing TiC, a TiN layer containing TiN, a TiCN layer containing TiCN, a TiCO layer containing TICO, a TiCNO layer containing TICNO, a TiON layer containing TION, and a TiB₂ layer containing TiB₂.

The lower layer may be constituted by a single layer or multiple layers (for example, two or three layers). The lower layer is preferably constituted by multiple layers, is more preferably constituted by two or three layers, and is even more preferably constituted by three layers. From the perspective of further improving the wear resistance and adhesion, the Ti compound constituting the Ti compound layer included in the lower layer preferably includes at least one layer selected from the group consisting of a TiN layer, a TiC layer, a TiCN layer, a TiCNO layer, and a TiCO layer. In the coated cutting tool of the present embodiment, where at least one layer of the lower layer is a TiCN layer, the wear resistance tends to be further improved. In the coated cutting tool of the present embodiment, at least one layer of the lower layer is a TiN layer, and where the TiN layer is formed on a surface of the substrate, adhesion tends to be further improved. In the coated cutting tool of the present embodiment, at least one layer of the lower layer is a TiCNO layer, and where the TICNO layer is formed so as to be in contact with the intermediate layer including the α-Al₂O₃ layer, adhesion tends to be further improved. When the lower layer is constituted by three layers: a TiC layer or a TiN layer, serving as a first layer, may be formed on a surface of the substrate; a TiCN layer, serving as a second layer, may be formed on a surface of the first layer; and a TICNO layer or a TiCO layer, serving as a third layer, may be formed on a surface of the second layer. In particular, as to the lower layer: a TiN layer, serving as a first layer, may be formed on a surface of the substrate; a TiCN layer, serving as a second layer, may be formed on a surface of the first layer; and a TiCNO layer, serving as a third layer, may be formed on a surface of the second layer.

The average thickness of the lower layer used in the present embodiment is preferably 3.0 μm or more and 15.0 μm or less. In the coated cutting tool of the present embodiment, since the average thickness of the lower layer is 3.0 μm or more, the wear resistance tends to be excellent. Meanwhile, in the coated cutting tool of the present embodiment, since the average thickness of the lower layer is 15.0 μm or less, the adhesion of the coating layer is improved, so that the chipping resistance and the fracture resistance tend to be excellent. From the same viewpoint, the average thickness of the lower layer is preferably 3.2 μm or more and 14.5 μm or less, and more preferably 4.0 μm or more and 13.0 μm or less.

In the lower layer used in the present embodiment, for example, from the viewpoint of further improving the wear resistance and fracture resistance, the average thickness of the TiC layer or the TiN layer is preferably 0.1 μm or more and 1.0 μm or less. From the same viewpoint, the average thickness of the TiC layer or the TiN layer is more preferably 0.1 μm or more and 0.5 μm or less, and even more preferably 0.1 μm or more and 0.3 μm or less.

In the lower layer used in the present embodiment, for example, from the viewpoint of further improving the wear resistance and fracture resistance, the average thickness of the TiCN layer is preferably 3.0 μm or more and 14.0 μm or less. From the same viewpoint, the average thickness of the TiCN layer is more preferably 3.5 μm or more and 12.5 μm or less, and even more preferably 4.5 μm or more and 9.5 μm or less.

In the lower layer used in the present embodiment, for example, from the viewpoint of further improving the wear resistance and fracture resistance, the average thickness of the TiCNO layer or the TiCO layer is preferably 0.1 μm or more and 1.0 μm or less. From the same viewpoint, the average thickness of the TICNO layer or the TiCO layer is more preferably 0.2 μm or more and 1.0 μm or less, and even more preferably 0.3 μm or more and 1.0 μm or less.

The Ti compound layer in the lower layer is composed of a Ti compound of Ti and an element of at least one kind selected from the group consisting of C, N, O and B. However, such Ti compound layer may contain a very small amount of components other than the above elements, as long as it provides the operation and effects of the lower layer.

### Intermediate Layer

The intermediate layer used in the present embodiment includes an α-Al₂O₃ layer containing α-aluminum oxide.

The average thickness of the intermediate layer used in the present embodiment is preferably 3.0 μm or more and 15.0 μm or less. In the coated cutting tool of the present embodiment, where the average thickness of the intermediate layer including the α-Al₂O₃ layer is 3.0 μm or more, the wear resistance tends to be excellent and the control of TC(0,0,12) described below is easy. Meanwhile, in the coated cutting tool of the present embodiment, where the average thickness of the intermediate layer including the α-Al₂O₃ layer is 15.0 μm or less, the adhesion of the coating layer is improved, so that the chipping resistance and the fracture resistance tend to be excellent. From the same viewpoint, the average thickness of the intermediate layer is more preferably 4.0 μm or more and 14.0 μm or less, and even more preferably 5.0 μm or more and 10.0 μm or less.

In the coated cutting tool of the present embodiment, the texture coefficient TC(0,0,12) of a (0,0,12) plane of the α-Al₂O₃ layer represented by the following formula (iii):

$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$

wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

Since the texture coefficient TC (0,0,12) of the (0,0,12) plane of the α-Al₂O₃ layer represented by the above formula (iii) is 5.0 or more in the intermediate layer, the coated cutting tool of the present embodiment tends to have excellent wear resistance. Meanwhile, where the texture coefficient TC(0,0,12) of the (0,0,12) plane of the α-Al₂O₃ layer represented by the above formula (iii) is 8.9 or less in the intermediate layer, the coated cutting tool of the present embodiment can be easily produced. From the same viewpoint, the texture coefficient TC(0,0,12) of the (0,0,12) plane of the α-Al₂O₃ layer represented by the above formula (iii) is more preferably 5.3 or more and 8.8 or less, and even more preferably 6.3 or more and 8.4 or less.

It should be noted that, in the present embodiment, the texture coefficient TC(0,0,12) of the (0,0,12) plane of the α-Al₂O₃ layer can be determined by the method described in Examples described below.

The intermediate layer only needs to include the α-Al₂O₃ layer containing α-aluminum oxide, and may or may not contain components other than α-aluminum oxide (α-Al₂O₃) as long as it provides the operation and effects of the present invention.

### Upper Layer

The upper layer used in the present embodiment includes a TiCN layer containing a Ti carbonitride. In the coated cutting tool of the present embodiment, since the upper layer includes the TiCN layer containing a Ti carbonitride, the hardness is high, so that the wear resistance is improved.

In addition, the TiCN layer of the upper layer used in the present embodiment satisfies the conditions represented by the following formula (i) and formula (ii):

$$30 \leq RSA \leq 70 \qquad ( i )$$

in the formula (i), where, in a cross section of the TiCN layer of the upper layer in a direction parallel to the surface of the substrate, a sum of areas of an entire cross section is taken as 100 area %, RSA is a ratio, in terms of area %, of a sum of cross-sectional areas of regions A where a misorientation A is 0 degrees or more and less than 15 degrees, the misorientation A being an angle, in terms of degrees, formed by a normal to the cross section of the TiCN layer and a normal to a (422) plane of grains of the TiCN layer; and

$$20 \leq RSB \leq 60 \qquad ( ii )$$

in the formula (ii), where, in a cross section of the TiCN layer of the upper layer in a direction parallel to the surface of the substrate, a sum of areas of an entire cross section is taken as 100 area %, RSB is a ratio, in terms of area %, of a sum of cross-sectional areas of regions B where a misorientation B is 0 degrees or more and less than 15 degrees, the misorientation B being an angle, in terms of degrees, formed by a normal to the cross section of the TiCN layer and a normal to a (220) plane of grains of the TiCN layer.

It should be noted here that each analysis position of the RSA and the RSB is a cross section exposed in a direction parallel to the surface of the substrate in a position where 60% or more of the average thickness of the TiCN layer in the upper layer is remained from the substrate side.

In the coated cutting tool of the present embodiment, since the RSA is 30 area % or more, the wear resistance is excellent. Meanwhile, in the coated cutting tool of the present embodiment, since the RSA is 70 area % or less, grains are prevented from falling off, so that the chipping resistance and the fracture resistance are excellent. From the same viewpoint, the RSA is more preferably 33 area % or more and 68 area % or less, and still more preferably 40 area % or more and 64 area % or less. In the coated cutting tool of the present embodiment, since the RSB is 20 area % or more, grains are prevented from falling off, so that the chipping resistance and the fracture resistance are excellent. Meanwhile, in the coated cutting tool of the present embodiment, since the RSB is 60 area % or less, the wear resistance is excellent. From the same viewpoint, the RSB is more preferably 22 area % or more and 58 area % or less, and still more preferably 24 area % or more and 56 area % or less.

It should be noted that, in the present embodiment, the RSA and the RSB can be determined by the method described in Examples described below.

In the coated cutting tool of the present embodiment, the average diameter of the region B is less than 5.0 μm in the TiCN layer of the upper layer. In the coated cutting tool of the present embodiment, the average diameter of the region B being less than 5.0 μm in the TiCN layer of the upper layer indicates that the regions B are dispersedly formed in the TiCN layer, allows the effect of preventing grains from falling off by having the above RSB of 20 area % or more to be effectively and reliably provided, and reduces the coarse regions B, so that the wear resistance is improved. In the coated cutting tool of the present embodiment, the average diameter of the region B is preferably 1.0 μm or more in the TiCN layer of the upper layer. In the coated cutting tool of the present embodiment, where the average diameter of the region B is 1.0 μm or more in the TiCN layer of the upper layer, the effect of preventing grains from falling off by the region B tends to be effectively and reliably provided. From the same viewpoint, the average diameter of the region B is more preferably 1.1 μm or more and 4.8 μm or less, and even more preferably 1.5 μm or more and 4.6 μm or less in the TiCN layer of the upper layer.

In the coated cutting tool of the present embodiment, the average diameter of the region A is preferably 5.0 μm or more and 30.0 μm or less in the TiCN layer of the upper layer. In the coated cutting tool of the present embodiment, where the average diameter of the region A is 5.0 μm or more in the TiCN layer of the upper layer, the effect of further improving the wear resistance by having the above RSA of 30 area % or more tends to be further improved. Meanwhile, in the coated cutting tool of the present embodiment, where the average diameter of the region A is 30.0 μm or less in the TiCN layer of the upper layer, production is easy. From the same viewpoint, the average diameter of the region A is more preferably 5.3 μm or more and 27.5 μm or less, and even more preferably 6.0 μm or more and 18.5 μm or less in the TiCN layer of the upper layer.

It should be noted that, in the present embodiment, as to the average diameter of the region B, an equivalent circle diameter is determined for each region, and the area average value of the resulting measurements is determined as “the average diameter of the region B”. In addition, the average diameter of the region A can also be determined in the same manner as “the average diameter of the region B”, except that the region to be specified is changed from the region B to the region A. Specifically, the average diameter can be determined by the method described in Examples described below.

In the coated cutting tool of the present embodiment, the average grain diameter of grains is preferably 0.3 μm or more and 1.2 μm or less in the TiCN layer of the upper layer. In the coated cutting tool of the present embodiment, where the average grain diameter of grains is 0.3 μm or more in the TiCN layer of the upper layer, the fracture resistance tends to be improved. Meanwhile, in the coated cutting tool of the present embodiment, where the average grain diameter of grains is 1.2 μm or less in the TiCN layer of the upper layer, the wear resistance tends to be improved. From the same viewpoint, the average grain diameter of grains is more preferably 0.5 μm or more and 1.1 μm or less in the TiCN layer of the upper layer.

It should be noted that, in the present embodiment, as to the average grain diameter of grains of the TiCN layer, an equivalent circle diameter is determined for each grain, and the area average value of the resulting measurements is determined as the average grain diameter. Specifically, the average diameter can be calculated by the method described in Examples described below.

The upper layer used in the present embodiment may include, other than the TiCN layer containing a Ti carbonitride, one or two or more Ti compound layers containing a Ti compound of Ti and an element of at least one kind selected from the group consisting of C, N and O.

Ti compound layers other than the TiCN layer in the upper layer are not particularly limited, and examples thereof include a TiC layer containing TiC, a TiN layer containing TIN, a TiCO layer containing TiCO, a TiCNO layer containing TICNO, and a TiON layer containing TION. Among these, a TIN layer and a TiCNO layer are preferable.

The upper layer may be constituted by a single layer or multiple layers (for example, two or three layers). When the upper layer is constituted by multiple layers, it is preferable to form the adhesion layer described below as a layer on a side in contact with the intermediate layer, and another layer may be formed on the surface of the TiCN layer opposite to the substrate. When the upper layer is constituted by two layers, a TiCN layer may be formed as a first layer, and a TiN layer may be formed on a surface of the first layer as a second layer. When the upper layer is constituted by three layers, a TiCNO layer or a TiCO layer, serving as an adhesion layer, may be formed on the side in contact with the intermediate layer; a TiCN layer, serving as a second layer, may be formed on the surface of the adhesion layer; and a TiN layer, serving as a third layer, may be formed on the surface of the second layer.

The average thickness of the upper layer used in the present embodiment is 1.0 μm or more and 6.0 μm or less. In the coated cutting tool of the present embodiment, since the average thickness of the upper layer is 1.0 μm or more, the wear resistance is excellent. Meanwhile, in the coated cutting tool of the present embodiment, since the average thickness of the upper layer is 6.0 μm or less, the adhesion of the coating layer is improved, so that the chipping resistance and the fracture resistance are excellent. From the same viewpoint, the average thickness of the upper layer is preferably 1.3 μm or more and 5.8 μm or less, and more preferably 1.4 μm or more and 5.7 μm or less.

The average thickness of the TiCN layer in the upper layer is preferably 1.0 μm or more and 5.5 μm or less. The coated cutting tool of the present embodiment tends to have improved wear resistance because the average thickness of the TiCN layer in the upper layer is 1.0 μm or more. Meanwhile, in the coated cutting tool of the present embodiment, since the average thickness of the TiCN layer in the upper layer is 5.5 μm or less, the adhesion of the coating layer is improved, so that the chipping resistance and the fracture resistance tend to be excellent. From the same viewpoint, the average thickness of the TiCN layer in the upper layer is more preferably 1.2 μm or more and 5.5 μm or less, and even more preferably 2.0 μm or more and 5.5 μm or less.

When the upper layer used in the present embodiment is in contact with the intermediate layer, it is preferable that the upper layer include at least one layer selected from the group consisting of a layer containing TiCO, a layer containing TiON, and a layer containing TiCNO as the adhesion layer on a side in contact with the intermediate layer (hereinafter, also simply referred to as the “adhesion layer”). With such an adhesion layer, the upper layer used in the present embodiment tends to have improved adhesion between the upper layer and the intermediate layer. From the same viewpoint, a TiCO layer or a TiCNO layer is more preferable as the adhesion layer.

In the upper layer used in the present embodiment, the average thickness of the adhesion layer is preferably 0.1 μm or more and 1.0 μm or less. In the coated cutting tool of the present embodiment, where the average thickness of the adhesion layer is 0.1 μm or more, the adhesion between the upper layer and the intermediate layer tends to be excellent and the chipping resistance tends to be improved. Meanwhile, in the coated cutting tool of the present embodiment, where the average thickness of the adhesion layer is 1.0 μm or less, the wear resistance tends to be improved. From the same viewpoint, the average thickness of the adhesion layer is more preferably 0.1 μm or more and 0.5 μm or less, and even more preferably 0.1 μm or more and 0.3 μm or less.

When the upper layer used in the present embodiment is constituted by multiple layers (for example, two or three layers), a TiN layer may be formed as the outermost layer that is farthest from the substrate among layers constituting the upper layer (hereinafter, also simply referred to as the “outermost layer”). In the coated cutting tool of the present embodiment, where the upper layer includes such outermost layer, the corner used tends to be easily identified.

In the upper layer used in the present embodiment, the range of the average thickness of such outermost layer is, for example, 0.05 μm or more and 1.0 μm or less, preferably 0.1 μm or more and 0.5 μm or less, and more preferably 0.1 μm or more and 0.3 μm or less.

The Ti compound layer in the upper layer is composed of a Ti compound of Ti and an element of at least one kind selected from the group consisting of C, N and O. However, such Ti compound layer may contain a very small amount of components other than the above elements, as long as it provides the operation and effects of the upper layer.

### Method for Forming Coating Layer

For example, the following methods can be used for forming the layers constituting the coating layer in the coated cutting tool of the present embodiment. However, the method of forming such layers is not limited thereto.

Firstly, a lower layer, being comprised of one or more Ti compound layers, is formed on a surface of a substrate. Next, from among such layers, a surface of a layer which is most distant from the substrate is oxidized. Thereafter, nuclei of the α-Al₂O₃ layer are formed on the surface of the layer which is most distant from the substrate, and the α-Al₂O₃ layer is formed after the nuclei have been formed. Further, an upper layer, being comprised of a Ti compound layer including a TiCN layer, is formed on a surface of the α-Al₂O₃ layer.

Examples of the method of forming the Ti compound layer in the lower layer include, but are not particularly limited to, the following methods.

For instance, a Ti compound layer, being comprised of a Ti nitride layer (hereinafter also referred to as a “TiN layer”), can be formed by chemical vapor deposition with a raw material composition of TiCl₄: from 5.0 mol % or more to 10.0 mol % or less, N₂: from 20 mol % or more to 60 mol % or less, and H₂: the balance, a temperature of from 850° C. or higher to 950° C. or lower, and a pressure of from 350 hPa or higher to 450 hPa or lower.

A Ti compound layer, being comprised of a Ti carbide layer (hereinafter also referred to as a “TiC layer”), can be formed by chemical vapor deposition with a raw material composition of TiCl₄: from 1.5 mol % or more to 3.5 mol % or less, CH₄: from 3.5 mol % or more to 5.5 mol % or less, and H₂: the balance, a temperature of from 950° C. or higher to 1,050° C. or lower, and a pressure of from 70 hPa or higher to 80 hPa or lower.

A Ti compound layer, being comprised of a Ti carbonitride layer (hereinafter also referred to as a “TiCN layer”), can be formed by chemical vapor deposition with a raw material composition of TiCl₄: from 5.0 mol % or more to 7.0 mol % or less, CH₃CN: from 0.5 mol % or more to 1.5 mol % or less, and H₂: the balance, a temperature of from 800° C. or higher to 900° C. or lower and a pressure of from 70 hPa or higher to 90 hPa or lower.

A Ti compound layer, being comprised of a Ti oxycarbonitride layer (hereinafter also referred to as a “TICNO layer”) in the lower layer, can be formed by chemical vapor deposition with a raw material composition of TiCl₄: from 3.0 mol % or more to 4.0 mol % or less, CO: from 0.5 mol % or more to 1.0 mol % or less, N₂: from 30 mol % or more to 40 mol % or less and H₂: the balance, a temperature of from 950° C. or higher to 1050° C. or lower and a pressure of from 50 hPa or higher to 150 hPa or lower.

A Ti compound layer, being comprised of a Ti carboxide layer (hereinafter also referred to as a “TiCO layer”), can be formed by chemical vapor deposition with a raw material composition of TiCl₄: from 1.0 mol % or more to 2.0 mol % or less, CO: from 2.0 mol % or more to 3.0 mol % or less, and H₂: the balance, a temperature of from 950° C. or higher to 1,050° C. or lower, and a pressure of from 50 hPa or higher to 150 hPa or lower.

An intermediate layer, being comprised of an α-Al₂O₃ layer (hereinafter also simply referred to as an “Al₂O₃ layer”), can be obtained by, for example, the method set forth below.

First, the oxidation of the surface of the layer which is most distant from the substrate among the lower layers is performed under the conditions of the raw material composition of CO₂: from 0.1 to 0.5 mol %, H₂S: from 0.05 to 0.15 mol %, and H₂: the balance, a temperature of from 900 to 950° C., and a pressure of from 60 to 80 hPa (oxidation step). The oxidation treatment time in this case is preferably 1 min to 5 min.

Thereafter, nuclei of the α-Al₂O₃ layer are formed by chemical vapor deposition with a raw material composition of AlCl₃: from 1.0 mol % or more to 4.0 mol % or less, CO: from 0.05 mol % or more to 2.0 mol % or less, CO₂: from 1.0 mol % or more to 3.0 mol % or less, HCl: from 2.0 mol % or more to 3.0 mol % or less, and H₂: the balance, a temperature of from 900° C. or higher to 950° C. or lower and a pressure of from 60 hPa or higher to 80 hPa or lower (nucleation step). A preferred time of the nucleation step is from 3 to 30 minutes.

Then, the α-Al₂O₃ layer is formed by chemical vapor deposition with a raw material composition of AlCl₃: from 3.5 mol % or more to 5.5 mol % or less, CO₂: from 3.0 mol % or more to 4.0 mol % or less, HCl: from 3.5 mol % or more to 4.5 mol % or less, H₂S: from 0.4 mol % or more to 1.0 mol % or less, and H₂: the balance, a temperature of from 980° C. or higher to 1,030° C. or lower and a pressure of from 70 hPa or higher to 90 hPa or lower (film formation step).

In order to set the texture coefficient TC(0,0,12) of the (0,0,12) plane of the α-Al₂O₃ layer represented by the formula (iii) to the above specific range in the intermediate layer, for example, the ratio of H₂S in the gas composition in the film formation step is only required to be controlled or the average thickness of the intermediate layer is only required to be controlled. More specifically, the texture coefficient TC(0,0,12) of the (0,0,12) plane of the α-Al₂O₃ layer represented by the formula (iii) tends to be increased by, for example, increasing the ratio of H₂S in the gas composition in the film formation step or increasing the average thickness of the intermediate layer.

In addition, the average diameter of the region A tends to be increased by carrying out the first step of forming the upper layer described below and increasing the texture coefficient TC(0,0,12) of the (0,0,12) plane of the α-Al₂O₃ layer represented by the formula (iii).

Further, examples of the method for forming the upper layer include, but are not particularly limited to, the following methods. Firstly, when an adhesion layer is formed on a side in contact with an intermediate layer (α-Al₂O₃ layer), a Ti compound layer (adhesion layer) is formed on a surface of the α-Al₂O₃ layer as the first step of forming the upper layer. Then, a TiCN layer is formed on the surface of the adhesion layer as the second step of forming the upper layer. Further, a Ti compound layer may be formed on a surface of the TiCN layer. A TiCN layer may be formed on the surface of the α-Al₂O₃ layer as the first step of forming the upper layer, and then, a TiCN layer may be further formed thereon as the second step of forming the upper layer.

For example, when a TiCNO layer is formed on the surface of the α-Al₂O₃ layer as the first step of forming the upper layer, the TICNO layer can be formed by chemical vapor deposition with a raw material composition of TiCl₄: from 7.5 to 10.0 mol %, C₂H₄: from 1.2 to 3.5 mol %, CH₃CN: from 0.7 to 1.2 mol %, CO: from 1.8 to 2.4 mol %, N₂: from 15.0 to 25.0 mol %, and H₂: the balance, a temperature of from 760 to 850° C., and a pressure of from 70 to 110 hPa.

For example, when a TiCN layer is formed on the surface of the α-Al₂O₃ layer as the first step of forming the upper layer, the TiCN layer can be formed by chemical vapor deposition with a raw material composition of TiCl₄: from 7.5 to 10.0 mol %, C₂H₄: from 1.2 to 3.5 mol %, CH₃CN: from 0.7 to 1.2 mol %, N₂: from 15.0 to 25.0 mol %, and H₂: the balance, a temperature of from 760 to 850° C., and a pressure of from 70 to 110 hPa. Here, the time for forming the TiCN layer is preferably from 15 to 25 minutes.

When a TiCN layer is formed as the second step of forming the upper layer, the TiCN layer can be formed by chemical vapor deposition with a raw material composition of TiCl₄: from 5.0 to 7.0 mol %, CH₃CN: from 1.5 to 2.5 mol %, N₂: from 15.0 to 25.0 mol %, and H₂: the balance, a temperature of from 800 to 900° C., and a pressure of from 70 to 120 hPa.

Further, when a TiN layer is formed on the surface of the TiCN layer, the TiN layer can be formed by chemical vapor deposition with a raw material composition of TiCl₄: from 5.0 to 10.0 mol %, N₂: from 20.0 to 60.0 mol %, and H₂: the balance, a temperature of from 950 to 1050° C., and a pressure of from 300 to 400 hPa.

In order to set the RSA to the above specific range in the TiCN layer of the upper layer, for example, the first step of forming the upper layer described above is only required to be carried out, and the texture coefficient TC(0,0,12) of a (0,0,12) plane of the α-Al₂O₃ layer represented by the formula (iii) is only required to be controlled. More specifically, the RSA tends to be increased by, for example, carrying out the first step of forming the upper layer described above, and increasing the texture coefficient TC(0,0,12) of a (0,0,12) plane of the α-Al₂O₃ layer represented by the formula (iii).

In order to set the RSB to the above specific range in the TiCN layer of the upper layer, for example, when the layer to be firstly formed on a surface of the intermediate layer is a TiCN layer in the first step of forming the upper layer, the ratio of C₂H₄ in the gas composition is only required to be controlled. More specifically, when the layer to be firstly formed on a surface of the intermediate layer is a TiCN layer in the first step of forming the upper layer, the RSB tends to be increased by increasing the ratio of C₂H₄ in the gas composition.

In order to set the RSB to the above specific range in the TiCN layer of the upper layer, for example, when the layer to be firstly formed on a surface of the intermediate layer is a TiCNO layer in the first step of forming the upper layer, the average thickness of the TICNO layer is only required to be controlled, and the ratio of C₂H₄ and/or CO in the gas composition is only required to be controlled. More specifically, when the layer to be firstly formed on a surface of the intermediate layer is a TiCNO layer in the first step of forming the upper layer, the RSB tends to be increased by increasing the average thickness of the TICNO layer and increasing the ratio of C₂H₄ and/or CO in the gas composition.

In order to set the average diameter of the region B to the above specific range in the TiCN layer of the upper layer, for example, the temperature is only required to be controlled in the first step of forming the upper layer. More specifically, the average diameter of the region B tends to be reduced by reducing the temperature in the first step of forming the upper layer.

In order to set the average grain diameter of grains to the above specific range in the TiCN layer of the upper layer, for example, the temperature is only required to be controlled in the second step of forming the upper layer. More specifically, the average grain diameter of grains tends to be increased by increasing the temperature in the second step of forming the upper layer. When the average grain diameter of grains is increased in the TiCN layer of the upper layer, the average diameters of the region A and the region B tend to be increased.

The thickness of each layer in the coating layer of the coated cutting tool of the present embodiment can be measured by observing a cross-sectional structure of the coated cutting tool, using an optical microscope, a scanning electron microscope (SEM), a FE-SEM, or the like. It should be noted that, as to the average thickness of each layer in the coated cutting tool of the present embodiment, such average thickness can be obtained by: measuring the thickness of each layer at three or more locations near the position 50 μm from the edge, toward the center of the flank of the coated cutting tool; and calculating the arithmetic mean of the resulting measurements. Further, the composition of each layer can be measured from a cross-sectional structure of the coated cutting tool of the present embodiment, using an energy-dispersive X-ray spectroscope (EDS), a wavelength-dispersive X-ray spectroscope (WDS), or the like.

### Examples

Hereinafter, the present invention will be described in greater detail with reference to examples, but the present invention is not limited to these examples.

As a substrate, a cutting insert made of a cemented carbide having a composition of 87.0% WC-8.6% Co-2.0% TIN-2.0% NbC-0.4% Cr₃C₂ (the above numbers are mass %) and having an insert shape of CNMG120408 (ISO standard) was prepared. The edges of these substrates were subjected to round honing by means of an SiC brush, and surfaces of the substrates were then washed.

### Invention Samples 1 to 26 and Comparative Samples 1 to 15

After the substrate surface was washed, a coating layer was formed by chemical vapor deposition. Firstly, the lower layer was formed on a surface of the substrate. Specifically, the substrate was inserted into an external heating chemical vapor deposition apparatus, and the A layer having the composition shown in Table 6 was formed under the conditions of the raw material composition, temperature and pressure shown in Table 1 on the surface of the substrate to have the average thickness shown in Table 6. Then, under the conditions of the raw material composition, temperature and pressure shown in Table 1, the B layer having the composition shown in Table 6 was formed on the surface of the A layer to have the average thickness shown in Table 6. Then, under the conditions of the raw material composition, temperature and pressure shown in Table 1, the C layer having the composition shown in Table 6 was formed on the surface of the B layer to have the average thickness shown in Table 6. As a result, a lower layer composed of three layers was formed. Thereafter, the surface of the lower layer was oxidized for the time shown in Table 2 under the conditions of composition, temperature and pressure shown in Table 2. Next, under the conditions of the raw material composition, temperature, and pressure shown in Table 2, and for the time shown in Table 2, nuclei of α-aluminum oxide (α-Al₂O₃) were formed on the surface of the lower layer subjected to the oxidation treatment. Further, under the conditions of the raw material composition, temperature and pressure shown in Table 3, the intermediate layer (α-Al₂O₃ layer) having the composition shown in Table 6 was formed on the surface of the lower layer and the nuclei of α-aluminum oxide (α-Al₂O₃) to have an average thickness shown in Table 6. Then, the upper layer was formed on the surface of the intermediate layer (α-Al₂O₃ layer). Specifically, firstly, as the first step of forming the upper layer, for Invention Samples 1 to 20 and 25 to 26 and Comparative Samples 1 to 11 and 13 to 16, the X layer (adhesion layer) having the composition shown in Table 7 was formed on the surface of the α-Al₂O₃ layer under the conditions of the raw material composition, temperature and pressure shown in Table 4 to have the average thickness shown in Table 7. For Invention Samples 21 to 24, under the conditions of the raw material composition, temperature and pressure shown in Table 4, the first step of forming the upper layer was carried out for 20 minutes, and a part of the Y layer (TiCN layer) having the composition shown in Table 7 (average thickness: about 0.2 μm) was formed on the surface of the intermediate layer (α-Al₂O₃ layer). It should be noted that, for Comparative Sample 12, the first step of forming the upper layer was not carried out. Next, as the second step of forming the upper layer, under the conditions of the raw material composition, temperature, and pressure shown in Table 5, the Y layer having the composition shown in Table 7 was formed on the surface of the X layer or the surface of the intermediate layer (α-Al₂O₃ layer) to have the average thickness shown in Table 7. For Invention Samples 21 to 24, the Y layer (TiCN layer) having the composition shown in Table 7 was formed on the surface of the intermediate layer (α-Al₂O₃ layer) to have the average thickness shown in Table 7 in total of the first step and second step of forming the upper layer. Further, for Invention Samples 5 to 10, 14 to 16, 20, 23 and 24, and Comparative Samples 1 to 3, 5 to 9, 12, 14 and 15, under the conditions of the raw material composition, temperature, and pressure shown in Table 1, the Z layer (the outermost layer) having the composition shown in Table 7 was formed on the surface of the Y layer to have the average thickness shown in Table 7. In this way, coated cutting tools of Invention Samples 1 to 26 and Comparative Samples 1 to 15 were obtained.

The thickness of each of the layers of each of the obtained samples was obtained as set forth below. That is, using an FE-SEM, such average thickness was obtained by: measuring the thickness of each layer at each of the three locations from the cross-sectional surface near the position 50 μm from the edge of the coated cutting tool, toward the center of the flank thereof; and calculating the arithmetic mean of the resulting measurements. The composition of each layer of the obtained samples was measured using EDS in a cross section in the vicinity of the position from the edge of the coated cutting tool to 50 μm toward the center of the flank.

TABLE 1

| | Composition | | | Raw material |
|---|---|---|---|---|
| | of each | Temperature | Pressure | composition |
| | layer | (° C.) | (hPa) | (mol %) |
| Lower | TiN | 900 | 400 | TiCl₄: 7.5%, |
| | | | | N₂: 40%, |
| | | | | H₂: 52.5% |
| layer | TiC | 1000 | 75 | TiCl₄: 2.4%, |
| | | | | CH₄: 4.6%, |
| | | | | H₂: 93.0% |
| | TiCN | 850 | 80 | TiCl₄: 6.0%, |
| | | | | CH₃CN: 1.15%, |
| | | | | H₂: 92.85% |
| | TiCNO | 1000 | 100 | TiCl₄: 3.5%, |
| | | | | CO: 0.7%, |
| | | | | N₂: 35.5%, |
| | | | | H₂: 60.3% |
| | TiCO | 1000 | 80 | TiCl₄: 1.3%, |
| | | | | CO: 2.7%, |
| | | | | H₂: 96.0% |
| Upper | TiN | 1000 | 350 | TiCl₄: 7.5%, |
| layer | | | | N₂: 40%, |
| | | | | H₂: 52.5% |

* Layers other than the TiN layer in the upper layer are formed under the conditions described in Tables 4 and 5.

TABLE 2

| | | | Raw material | |
|---|---|---|---|---|
| | Temperature | Pressure | composition | Time |
| Step | (° C.) | (hPa) | (mol %) | (min) |
| Oxidation | 920 | 70 | CO₂: 0.3%, | 3 |
| step | | | H₂S: 0.1%, | |
| | | | H₂: 99.6% | |
| Nucleation | 920 | 70 | AlCl₃: 3.5%, | 6 |
| step | | | CO₂: 2.0%, | |
| | | | CO: 1.0%, HCl: 2.5%, | |
| | | | H₂: 91.0% | |

| | |
|---|---|
| Film formation | The layer was formed under the |
| step | conditions described in Table 3. |

TABLE 3

| | Intermediate layer (film formation step) | | | | | | |
|---|---|---|---|---|---|---|---|
| Sample | Temperature | Pressure | Raw material composition (mol %) | | | | |
| Number | (° C.) | (hPa) | AlCl₃ | CO₂ | HCl | H₂S | H₂ |
| Invention Sample 1 | 1000 | 70 | 3.5 | 3.0 | 4.5 | 0.7 | 88.3 |
| Invention Sample 2 | 1010 | 80 | 3.5 | 3.5 | 3.5 | 0.7 | 88.8 |
| Invention Sample 3 | 1010 | 80 | 3.5 | 3.0 | 4.0 | 0.7 | 88.8 |
| Invention Sample 4 | 1000 | 80 | 4.0 | 4.0 | 4.0 | 0.7 | 87.3 |
| Invention Sample 5 | 980 | 70 | 4.0 | 3.5 | 4.0 | 0.4 | 88.1 |
| Invention Sample 6 | 1030 | 70 | 3.5 | 3.0 | 3.5 | 1.0 | 89.0 |
| Invention Sample 7 | 1010 | 90 | 5.5 | 4.0 | 3.5 | 0.7 | 86.3 |
| Invention Sample 8 | 1010 | 70 | 3.5 | 3.5 | 4.5 | 0.7 | 87.8 |
| Invention Sample 9 | 1010 | 70 | 3.5 | 3.5 | 4.5 | 0.7 | 87.8 |
| Invention Sample 10 | 1010 | 80 | 5.0 | 4.0 | 4.5 | 0.7 | 85.8 |
| Invention Sample 11 | 1010 | 70 | 3.5 | 3.5 | 3.5 | 0.7 | 88.8 |
| Invention Sample 12 | 1010 | 90 | 3.5 | 3.5 | 3.5 | 0.7 | 88.8 |
| Invention Sample 13 | 1020 | 70 | 5.0 | 3.5 | 4.0 | 0.9 | 86.6 |
| Invention Sample 14 | 1010 | 90 | 4.5 | 3.0 | 4.0 | 0.7 | 87.8 |
| Invention Sample 15 | 1010 | 70 | 3.5 | 3.0 | 3.5 | 0.7 | 89.3 |
| Invention Sample 16 | 1010 | 80 | 3.5 | 3.5 | 3.5 | 0.7 | 88.8 |
| Invention Sample 17 | 990 | 70 | 5.0 | 3.5 | 4.0 | 0.7 | 86.8 |
| Invention Sample 18 | 1030 | 80 | 4.0 | 3.5 | 3.5 | 0.7 | 88.3 |
| Invention Sample 19 | 1010 | 70 | 4.0 | 3.5 | 4.5 | 0.7 | 87.3 |
| Invention Sample 20 | 1010 | 70 | 3.5 | 3.0 | 3.5 | 0.8 | 89.2 |
| Invention Sample 21 | 1000 | 90 | 4.0 | 3.0 | 4.0 | 1.0 | 88.0 |
| Invention Sample 22 | 1000 | 90 | 4.0 | 3.0 | 3.5 | 0.5 | 89.0 |
| Invention Sample 23 | 1000 | 90 | 3.5 | 3.0 | 4.5 | 0.7 | 88.3 |
| Invention Sample 24 | 1000 | 70 | 3.5 | 3.5 | 3.5 | 0.7 | 88.8 |
| Invention Sample 25 | 1010 | 80 | 4.0 | 3.5 | 3.5 | 0.7 | 88.3 |
| Invention Sample 26 | 1010 | 80 | 4.5 | 3.5 | 4.5 | 0.7 | 86.8 |
| Comparative Sample 1 | 980 | 90 | 4.0 | 4.0 | 3.5 | 0.2 | 88.3 |
| Comparative Sample 2 | 1000 | 70 | 4.0 | 3.5 | 4.5 | 0.2 | 87.8 |
| Comparative Sample 3 | 1000 | 70 | 4.0 | 4.0 | 4.0 | 0.2 | 87.8 |
| Comparative Sample 4 | 1030 | 70 | 5.0 | 4.0 | 4.5 | 1.0 | 85.5 |
| Comparative Sample 5 | 1010 | 80 | 4.0 | 3.5 | 3.5 | 0.7 | 88.3 |
| Comparative Sample 6 | 1010 | 80 | 4.0 | 3.5 | 4.0 | 0.7 | 87.8 |
| Comparative Sample 7 | 1010 | 80 | 5.5 | 3.5 | 3.5 | 0.7 | 86.8 |
| Comparative Sample 8 | 1010 | 70 | 3.5 | 3.5 | 3.5 | 0.7 | 88.8 |
| Comparative Sample 9 | 980 | 70 | 4.0 | 4.0 | 4.5 | 0.8 | 86.7 |
| Comparative Sample 10 | 1010 | 90 | 4.5 | 3.5 | 3.5 | 0.7 | 87.8 |
| Comparative Sample 11 | 1010 | 90 | 4.5 | 3.5 | 4.0 | 0.7 | 87.3 |
| Comparative Sample 12 | 1010 | 80 | 4.5 | 3.5 | 4.0 | 0.7 | 87.3 |
| Comparative Sample 13 | 1010 | 80 | 3.5 | 4.0 | 3.5 | 0.7 | 88.3 |
| Comparative Sample 14 | 990 | 80 | 4.0 | 4.0 | 4.5 | 0.7 | 86.8 |
| Comparative Sample 15 | 1020 | 8 | 4.0 | 4.0 | 4.0 | 0.7 | 87.3 |

TABLE 4

| | Upper layer (first step) | | | | | | | |
|---|---|---|---|---|---|---|---|---|
| Sample | Temperature | Pressure | Raw material composition (mol %) | | | | | |
| Number | (° C.) | (hPa) | TiCl₄ | C₂H₄ | CH₃CN | CO | N₂ | H₂ |
| Invention Sample 1 | 800 | 90 | 8.0 | 2.0 | 0.7 | 2.4 | 20.0 | 66.9 |
| Invention Sample 2 | 780 | 100 | 9.0 | 2.0 | 1.0 | 2.0 | 25.0 | 61.0 |
| Invention Sample 3 | 820 | 90 | 8.0 | 2.0 | 1.0 | 2.2 | 20.0 | 66.8 |
| Invention Sample 4 | 850 | 80 | 8.0 | 2.0 | 1.1 | 2.0 | 15.0 | 71.9 |
| Invention Sample 5 | 800 | 100 | 9.5 | 2.0 | 0.8 | 2.4 | 20.0 | 65.3 |
| Invention Sample 6 | 800 | 90 | 8.5 | 2.0 | 0.8 | 2.0 | 15.0 | 71.7 |
| Invention Sample 7 | 800 | 80 | 7.5 | 1.2 | 0.8 | 1.8 | 25.0 | 63.7 |
| Invention Sample 8 | 780 | 90 | 7.5 | 3.5 | 0.9 | 2.4 | 15.0 | 70.7 |
| Invention Sample 9 | 800 | 90 | 7.5 | 3.5 | 0.9 | 2.4 | 15.0 | 70.7 |
| Invention Sample 10 | 800 | 70 | 8.0 | 2.0 | 0.9 | 2.0 | 15.0 | 72.1 |
| Invention Sample 11 | 800 | 110 | 8.0 | 2.0 | 1.1 | 2.2 | 20.0 | 66.7 |
| Invention Sample 12 | 800 | 90 | 9.0 | 2.0 | 1.2 | 2.0 | 20.0 | 65.8 |
| Invention Sample 13 | 800 | 90 | 8.5 | 2.0 | 1.0 | 2.0 | 25.0 | 61.5 |
| Invention Sample 14 | 760 | 90 | 10.0 | 2.0 | 0.9 | 2.0 | 20.0 | 65.1 |
| Invention Sample 15 | 800 | 80 | 8.0 | 2.0 | 1.0 | 2.0 | 20.0 | 67.0 |
| Invention Sample 16 | 800 | 90 | 7.5 | 2.0 | 0.9 | 1.8 | 20.0 | 67.8 |
| Invention Sample 17 | 800 | 100 | 8.0 | 2.0 | 1.0 | 2.0 | 15.0 | 72.0 |
| Invention Sample 18 | 800 | 90 | 9.0 | 2.0 | 0.8 | 2.2 | 25.0 | 61.0 |
| Invention Sample 19 | 800 | 90 | 8.5 | 2.0 | 1.0 | 2.0 | 25.0 | 61.5 |
| Invention Sample 20 | 800 | 70 | 9.5 | 2.0 | 1.1 | 1.8 | 15.0 | 70.6 |
| Invention Sample 21 | 800 | 80 | 8.0 | 3.0 | 1.0 | 0.0 | 15.0 | 73.0 |
| Invention Sample 22 | 800 | 90 | 8.5 | 3.0 | 1.2 | 0.0 | 15.0 | 72.3 |
| Invention Sample 23 | 800 | 110 | 9.5 | 2.0 | 0.9 | 0.0 | 15.0 | 72.6 |
| Invention Sample 24 | 800 | 70 | 9.0 | 3.5 | 1.0 | 0.0 | 15.0 | 71.5 |
| Invention Sample 25 | 800 | 90 | 8.5 | 2.0 | 0.9 | 2.0 | 20.0 | 66.6 |
| Invention Sample 26 | 800 | 100 | 7.5 | 2.0 | 1.0 | 2.0 | 25.0 | 62.5 |
| Comparative Sample 1 | 800 | 90 | 10.0 | 2.0 | 0.9 | 2.0 | 20.0 | 65.1 |
| Comparative Sample 2 | 800 | 90 | 10.0 | 2.0 | 1.1 | 2.0 | 20.0 | 64.9 |
| Comparative Sample 3 | 800 | 90 | 10.0 | 2.0 | 1.0 | 2.0 | 20.0 | 65.0 |
| Comparative Sample 4 | 800 | 90 | 10.0 | 2.0 | 1.2 | 2.0 | 25.0 | 59.8 |
| Comparative Sample 5 | 800 | 90 | 10.0 | 0.5 | 1.0 | 2.0 | 15.0 | 71.5 |
| Comparative Sample 6 | 800 | 90 | 10.0 | 0.5 | 0.8 | 1.8 | 20.0 | 66.9 |
| Comparative Sample 7 | 800 | 90 | 10.0 | 4.0 | 1.0 | 2.2 | 15.0 | 67.8 |
| Comparative Sample 8 | 800 | 90 | 10.0 | 4.0 | 1.2 | 2.4 | 15.0 | 67.4 |
| Comparative Sample 9 | 800 | 90 | 10.0 | 4.0 | 1.0 | 2.0 | 15.0 | 68.0 |
| Comparative Sample 10 | 800 | 90 | 10.0 | 2.0 | 0.9 | 2.0 | 20.0 | 65.1 |
| Comparative Sample 11 | 880 | 90 | 10.0 | 2.0 | 1.0 | 1.8 | 20.0 | 65.2 |
| Comparative Sample 12 | — | — | — | — | — | — | — | — |
| Comparative Sample 13 | 800 | 90 | 10.0 | 2.0 | 1.0 | 2.0 | 20.0 | 65.0 |
| Comparative Sample 14 | 800 | 90 | 10.0 | 2.0 | 0.8 | 2.0 | 15.0 | 70.2 |
| Comparative Sample 15 | 800 | 90 | 10.0 | 2.0 | 1.0 | 1.8 | 25.0 | 60.2 |

TABLE 5

| | Upper layer (second step) | | | | | |
|---|---|---|---|---|---|---|
| Sample | Temperature | Pressure | Raw material composition (mol %) | | | |
| Number | (° C.) | (hPa) | TiCl₄ | CH₃CN | N₂ | H₂ |
| Invention Sample 1 | 840 | 80 | 5.5 | 1.5 | 20.0 | 73.0 |
| Invention Sample 2 | 840 | 80 | 5.5 | 2.0 | 15.0 | 77.5 |
| Invention Sample 3 | 840 | 90 | 5.5 | 1.5 | 20.0 | 73.0 |
| Invention Sample 4 | 840 | 90 | 6.0 | 2.0 | 20.0 | 72.0 |
| Invention Sample 5 | 840 | 80 | 6.0 | 2.0 | 20.0 | 72.0 |
| Invention Sample 6 | 840 | 80 | 6.0 | 2.0 | 25.0 | 67.0 |
| Invention Sample 7 | 840 | 90 | 6.0 | 2.0 | 20.0 | 72.0 |
| Invention Sample 8 | 820 | 80 | 6.0 | 2.0 | 25.0 | 67.0 |
| Invention Sample 9 | 840 | 80 | 6.0 | 2.0 | 25.0 | 67.0 |
| Invention Sample 10 | 800 | 120 | 5.5 | 1.5 | 15.0 | 78.0 |
| Invention Sample 11 | 820 | 100 | 6.0 | 2.0 | 20.0 | 72.0 |
| Invention Sample 12 | 870 | 90 | 6.0 | 2.0 | 20.0 | 72.0 |
| Invention Sample 13 | 860 | 70 | 5.0 | 2.5 | 20.0 | 72.5 |
| Invention Sample 14 | 900 | 70 | 5.0 | 2.0 | 20.0 | 73.0 |
| Invention Sample 15 | 840 | 100 | 6.0 | 2.0 | 15.0 | 77.0 |
| Invention Sample 16 | 840 | 100 | 6.5 | 2.0 | 20.0 | 71.5 |
| Invention Sample 17 | 840 | 90 | 6.0 | 2.0 | 25.0 | 67.0 |
| Invention Sample 18 | 840 | 100 | 5.5 | 2.0 | 20.0 | 72.5 |
| Invention Sample 19 | 840 | 80 | 6.0 | 2.0 | 20.0 | 72.0 |
| Invention Sample 20 | 840 | 100 | 6.5 | 2.5 | 20.0 | 71.0 |
| Invention Sample 21 | 840 | 110 | 6.0 | 2.0 | 25.0 | 67.0 |
| Invention Sample 22 | 840 | 100 | 6.0 | 2.0 | 25.0 | 67.0 |
| Invention Sample 23 | 840 | 100 | 5.5 | 2.0 | 20.0 | 72.5 |
| Invention Sample 24 | 840 | 90 | 6.0 | 2.0 | 20.0 | 72.0 |
| Invention Sample 25 | 840 | 100 | 7.0 | 2.0 | 20.0 | 71.0 |
| Invention Sample 26 | 840 | 80 | 6.0 | 2.0 | 20.0 | 72.0 |
| Comparative Sample 1 | 840 | 90 | 6.0 | 2.5 | 20.0 | 71.5 |
| Comparative Sample 2 | 880 | 80 | 7.0 | 2.0 | 25.0 | 66.0 |
| Comparative Sample 3 | 860 | 90 | 6.5 | 2.5 | 25.0 | 66.0 |
| Comparative Sample 4 | 840 | 100 | 6.0 | 2.0 | 20.0 | 72.0 |
| Comparative Sample 5 | 840 | 80 | 6.0 | 1.5 | 20.0 | 72.5 |
| Comparative Sample 6 | 880 | 80 | 7.0 | 2.0 | 20.0 | 71.0 |
| Comparative Sample 7 | 840 | 100 | 6.0 | 2.5 | 20.0 | 71.5 |
| Comparative Sample 8 | 800 | 120 | 5.0 | 2.0 | 20.0 | 73.0 |
| Comparative Sample 9 | 800 | 120 | 5.0 | 2.0 | 20.0 | 73.0 |
| Comparative Sample 10 | 900 | 70 | 5.0 | 2.0 | 25.0 | 68.0 |
| Comparative Sample 11 | 840 | 100 | 5.5 | 2.0 | 20.0 | 72.5 |
| Comparative Sample 12 | 840 | 80 | 7.0 | 1.5 | 20.0 | 71.5 |
| Comparative Sample 13 | 840 | 90 | 6.0 | 2.0 | 15.0 | 77.0 |
| Comparative Sample 14 | 840 | 90 | 6.0 | 1.5 | 15.0 | 77.5 |
| Comparative Sample 15 | 840 | 90 | 6.0 | 2.0 | 20.0 | 72.0 |

TABLE 6

| | Coating layer | | | | | | | | | |
|---|---|---|---|---|---|---|---|---|---|---|
| | Lower layer | | | | | | | | | |
| | | | | | | | Average | | | |
| | A layer | | B layer | | C layer | | thickness | Intermediate layer | | |
| | | Average | | Average | | Average | of entire | | | Average |
| Sample | | thickness | | thickness | | thickness | layer | | Crystal | thickness |
| Number | Composition | (μm) | Composition | (μm) | Composition | (μm) | (μm) | Composition | system | (μm) |
| Invention | TiN | 0.2 | TiCN | 8.0 | TiCNO | 0.3 | 8.5 | Al₂O₃ | α | 7.0 |
| Sample 1 | | | | | | | | | | |
| Invention | TiN | 0.2 | TiCN | 8.0 | TiCNO | 0.3 | 8.5 | Al₂O₃ | α | 7.0 |
| Sample 2 | | | | | | | | | | |
| Invention | TiN | 0.2 | TiCN | 8.0 | TiCNO | 0.3 | 8.5 | Al₂O₃ | α | 7.0 |
| Sample 3 | | | | | | | | | | |
| Invention | TiN | 0.2 | TiCN | 8.0 | TiCNO | 0.3 | 8.5 | Al₂O₃ | α | 7.0 |
| Sample 4 | | | | | | | | | | |
| Invention | TiN | 0.2 | TiCN | 8.0 | TiCNO | 0.3 | 8.5 | Al₂O₃ | α | 7.0 |
| Sample 5 | | | | | | | | | | |
| Invention | TiN | 0.2 | TiCN | 8.0 | TiCNO | 0.3 | 8.5 | Al₂O₃ | α | 7.0 |
| Sample 6 | | | | | | | | | | |
| Invention | TiN | 0.2 | TiCN | 8.0 | TiCNO | 0.3 | 8.5 | Al₂O₃ | α | 7.0 |
| Sample 7 | | | | | | | | | | |
| Invention | TiN | 0.2 | TiCN | 8.0 | TiCNO | 0.3 | 8.5 | Al₂O₃ | α | 7.0 |
| Sample 8 | | | | | | | | | | |
| Invention | TiN | 0.2 | TiCN | 8.0 | TiCNO | 1.0 | 9.2 | Al₂O₃ | α | 7.0 |
| Sample 9 | | | | | | | | | | |
| Invention | TiN | 0.2 | TiCN | 8.0 | TiCNO | 0.3 | 8.5 | Al₂O₃ | α | 7.0 |
| Sample 10 | | | | | | | | | | |
| Invention | TiN | 1.0 | TiCN | 8.0 | TiCNO | 0.3 | 9.3 | Al₂O₃ | α | 7.0 |
| Sample 11 | | | | | | | | | | |
| Invention | TiN | 0.2 | TiCN | 8.0 | TiCNO | 0.3 | 8.5 | Al₂O₃ | α | 7.0 |
| Sample 12 | | | | | | | | | | |
| Invention | TiN | 0.1 | TiCN | 3.0 | TiCNO | 0.1 | 3.2 | Al₂O₃ | α | 14.0 |
| Sample 13 | | | | | | | | | | |
| Invention | TiN | 0.2 | TiCN | 8.0 | TiCNO | 0.3 | 8.5 | Al₂O₃ | α | 7.0 |
| Sample 14 | | | | | | | | | | |
| Invention | TiC | 0.2 | TiCN | 8.0 | TiCNO | 0.3 | 8.5 | Al₂O₃ | α | 7.0 |
| Sample 15 | | | | | | | | | | |
| Invention | TiN | 0.2 | TiCN | 8.0 | TiCO | 0.3 | 8.5 | Al₂O₃ | α | 7.0 |
| Sample 16 | | | | | | | | | | |
| Invention | TiN | 0.2 | TiCN | 9.5 | TiCNO | 0.3 | 10.0 | Al₂O₃ | α | 8.0 |
| Sample 17 | | | | | | | | | | |
| Invention | TiN | 0.2 | TiCN | 7.0 | TiCNO | 0.3 | 7.5 | Al₂O₃ | α | 5.5 |
| Sample 18 | | | | | | | | | | |
| Invention | TiN | 0.2 | TiCN | 3.5 | TiCNO | 0.3 | 4.0 | Al₂O₃ | α | 4.0 |
| Sample 19 | | | | | | | | | | |
| Invention | TiN | 0.2 | TiCN | 14.0 | TiCNO | 0.3 | 14.5 | Al₂O₃ | α | 10.0 |
| Sample 20 | | | | | | | | | | |
| Invention | TiN | 0.2 | TiCN | 8.0 | TiCNO | 0.3 | 8.5 | Al₂O₃ | α | 7.0 |
| Sample 21 | | | | | | | | | | |
| Invention | TiN | 0.2 | TiCN | 8.0 | TiCNO | 0.3 | 8.5 | Al₂O₃ | α | 7.0 |
| Sample 22 | | | | | | | | | | |
| Invention | TiN | 0.2 | TiCN | 8.0 | TiCNO | 0.3 | 8.5 | Al₂O₃ | α | 7.0 |
| Sample 23 | | | | | | | | | | |
| Invention | TiN | 0.2 | TiCN | 8.0 | TiCNO | 0.3 | 8.5 | Al₂O₃ | α | 7.0 |
| Sample 24 | | | | | | | | | | |
| Invention | TiN | 0.2 | TiCN | 4.5 | TiCNO | 0.3 | 5.0 | Al₂O₃ | α | 5.0 |
| Sample 25 | | | | | | | | | | |
| Invention | TiN | 0.2 | TiCN | 12.5 | TiCNO | 0.3 | 13.0 | Al₂O₃ | α | 10.0 |
| Sample 26 | | | | | | | | | | |
| Comparative | TiN | 0.2 | TiCN | 8.0 | TiCNO | 0.3 | 8.5 | Al₂O₃ | α | 7.0 |
| Sample 1 | | | | | | | | | | |
| Comparative | TiN | 0.2 | TiCN | 8.0 | TiCNO | 0.3 | 8.5 | Al₂O₃ | α | 7.0 |
| Sample 2 | | | | | | | | | | |
| Comparative | TiN | 0.2 | TiCN | 8.0 | TiCNO | 0.3 | 8.5 | Al₂O₃ | α | 7.0 |
| Sample 3 | | | | | | | | | | |
| Comparative | TiN | 0.2 | TiCN | 4.0 | TiCNO | 0.3 | 4.5 | Al₂O₃ | α | 12.0 |
| Sample 4 | | | | | | | | | | |
| Comparative | TiN | 0.2 | TiCN | 8.0 | TiCNO | 0.3 | 8.5 | Al₂O₃ | α | 7.0 |
| Sample 5 | | | | | | | | | | |
| Comparative | TiN | 0.2 | TiCN | 8.0 | TiCNO | 0.3 | 8.5 | Al₂O₃ | α | 7.0 |
| Sample 6 | | | | | | | | | | |
| Comparative | TiN | 0.2 | TiCN | 8.0 | TiCNO | 0.3 | 8.5 | Al₂O₃ | α | 7.0 |
| Sample 7 | | | | | | | | | | |
| Comparative | TiN | 0.2 | TiCN | 8.0 | TiCNO | 0.3 | 8.5 | Al₂O₃ | α | 7.0 |
| Sample 8 | | | | | | | | | | |
| Comparative | TiN | 0.2 | TiCN | 8.0 | TiCNO | 0.3 | 8.5 | Al₂O₃ | α | 7.0 |
| Sample 9 | | | | | | | | | | |
| Comparative | TiN | 0.2 | TiCN | 8.0 | TiCNO | 0.3 | 8.5 | Al₂O₃ | α | 7.0 |
| Sample 10 | | | | | | | | | | |
| Comparative | TiN | 0.2 | TiCN | 8.0 | TiCNO | 0.3 | 8.5 | Al₂O₃ | α | 7.0 |
| Sample 11 | | | | | | | | | | |
| Comparative | TiN | 0.2 | TiCN | 8.0 | TiCNO | 0.3 | 8.5 | Al₂O₃ | α | 7.0 |
| Sample 12 | | | | | | | | | | |
| Comparative | TiN | 0.2 | TiCN | 8.0 | TiCNO | 0.3 | 8.5 | Al₂O₃ | α | 7.0 |
| Sample 13 | | | | | | | | | | |
| Comparative | TiN | 0.2 | TiCN | 2.0 | TiCNO | 0.3 | 2.5 | Al₂O₃ | α | 2.0 |
| Sample 14 | | | | | | | | | | |
| Comparative | TiN | 0.2 | TiCN | 14.0 | TiCNO | 0.3 | 14.5 | Al₂O₃ | α | 15.5 |
| Sample 15 | | | | | | | | | | |

TABLE 7

| | Coating layer | | | | | | | |
|---|---|---|---|---|---|---|---|---|
| | Upper layer | | | | | | | Average |
| | | | | | | | Average | thickness |
| | X layer | | TiCN layer (Y layer) | | Z layer | | thickness | of entire |
| | | Average | | Average | | Average | of entire | coating |
| Sample | | thickness | | thickness | | thickness | layer | layer |
| Number | Composition | (μm) | Composition | (μm) | Composition | (μm) | (μm) | (μm) |
| Invention | TiCNO | 0.3 | TiCN | 3.0 | — | — | 3.3 | 18.8 |
| Sample 1 | | | | | | | | |
| Invention | TiCNO | 0.3 | TiCN | 3.0 | — | — | 3.3 | 18.8 |
| Sample 2 | | | | | | | | |
| Invention | TiCNO | 0.3 | TiCN | 3.0 | — | — | 3.3 | 18.8 |
| Sample 3 | | | | | | | | |
| Invention | TiCNO | 0.3 | TiCN | 3.0 | — | — | 3.3 | 18.8 |
| Sample 4 | | | | | | | | |
| Invention | TiCNO | 0.3 | TiCN | 3.0 | TiN | 0.3 | 3.6 | 19.1 |
| Sample 5 | | | | | | | | |
| Invention | TiCNO | 0.3 | TiCN | 3.0 | TiN | 0.3 | 3.6 | 19.1 |
| Sample 6 | | | | | | | | |
| Invention | TiCNO | 0.3 | TiCN | 3.0 | TiN | 0.3 | 3.6 | 19.1 |
| Sample 7 | | | | | | | | |
| Invention | TiCNO | 0.3 | TiCN | 3.0 | TiN | 0.3 | 3.6 | 19.1 |
| Sample 8 | | | | | | | | |
| Invention | TiCNO | 0.3 | TiCN | 3.0 | TiN | 0.3 | 3.6 | 19.8 |
| Sample 9 | | | | | | | | |
| Invention | TiCNO | 0.3 | TiCN | 3.0 | TiN | 0.3 | 3.6 | 19.1 |
| Sample 10 | | | | | | | | |
| Invention | TiCNO | 0.3 | TiCN | 3.0 | — | — | 3.3 | 19.6 |
| Sample 11 | | | | | | | | |
| Invention | TiCNO | 0.3 | TiCN | 3.0 | — | — | 3.3 | 18.8 |
| Sample 12 | | | | | | | | |
| Invention | TiCNO | 0.3 | TiCN | 3.0 | — | — | 3.3 | 20.5 |
| Sample 13 | | | | | | | | |
| Invention | TiCNO | 0.3 | TiCN | 3.0 | TiN | 0.3 | 3.6 | 19.1 |
| Sample 14 | | | | | | | | |
| Invention | TiCNO | 0.3 | TiCN | 3.0 | TiN | 0.3 | 3.6 | 19.1 |
| Sample 15 | | | | | | | | |
| Invention | TiCNO | 0.3 | TiCN | 3.0 | TiN | 0.3 | 3.6 | 19.1 |
| Sample 16 | | | | | | | | |
| Invention | TiCNO | 0.3 | TiCN | 1.0 | — | — | 1.3 | 19.3 |
| Sample 17 | | | | | | | | |
| Invention | TiCNO | 0.3 | TiCN | 5.5 | — | — | 5.8 | 18.8 |
| Sample 18 | | | | | | | | |
| Invention | TiCNO | 0.3 | TiCN | 3.0 | — | — | 3.3 | 11.3 |
| Sample 19 | | | | | | | | |
| Invention | TiCNO | 0.3 | TiCN | 3.0 | TiN | 0.3 | 3.6 | 28.1 |
| Sample 20 | | | | | | | | |
| Invention | — | — | TiCN | 3.0 | — | — | 3.0 | 18.5 |
| Sample 21 | | | | | | | | |
| Invention | — | — | TiCN | 3.0 | — | — | 3.0 | 18.5 |
| Sample 22 | | | | | | | | |
| Invention | — | — | TiCN | 1.2 | TiN | 0.2 | 1.4 | 16.9 |
| Sample 23 | | | | | | | | |
| Invention | — | — | TiCN | 5.5 | TiN | 0.2 | 5.7 | 21.2 |
| Sample 24 | | | | | | | | |
| Invention | TiCNO | 1.0 | TiCN | 2.5 | — | — | 3.5 | 13.5 |
| Sample 25 | | | | | | | | |
| Invention | TiCNO | 0.1 | TiCN | 2.0 | — | — | 2.1 | 25.1 |
| Sample 26 | | | | | | | | |
| Comparative | TiCNO | 0.3 | TiCN | 3.0 | TiN | 0.3 | 3.6 | 19.1 |
| Sample 1 | | | | | | | | |
| Comparative | TiCNO | 0.3 | TiCN | 3.0 | TiN | 0.3 | 3.6 | 19.1 |
| Sample 2 | | | | | | | | |
| Comparative | TiCNO | 0.3 | TiCN | 3.0 | TiN | 0.3 | 3.6 | 19.1 |
| Sample 3 | | | | | | | | |
| Comparative | TiCNO | 0.3 | TiCN | 3.0 | — | — | 3.3 | 19.8 |
| Sample 4 | | | | | | | | |
| Comparative | TiCNO | 0.3 | TiCN | 3.0 | TiN | 0.3 | 3.6 | 19.1 |
| Sample 5 | | | | | | | | |
| Comparative | TiCNO | 0.3 | TiCN | 3.0 | TiN | 0.3 | 3.6 | 19.1 |
| Sample 6 | | | | | | | | |
| Comparative | TiCNO | 0.3 | TiCN | 3.0 | TiN | 0.3 | 3.6 | 19.1 |
| Sample 7 | | | | | | | | |
| Comparative | TiCNO | 0.3 | TiCN | 3.0 | TiN | 0.3 | 3.6 | 19.1 |
| Sample 8 | | | | | | | | |
| Comparative | TiCNO | 0.3 | TiCN | 3.0 | TiN | 0.3 | 3.6 | 19.1 |
| Sample 9 | | | | | | | | |
| Comparative | TiCNO | 0.3 | TiCN | 3.0 | — | — | 3.3 | 18.8 |
| Sample 10 | | | | | | | | |
| Comparative | TiCNO | 0.3 | TiCN | 3.0 | — | — | 3.3 | 18.8 |
| Sample 11 | | | | | | | | |
| Comparative | — | — | TiCN | 3.0 | TiN | 0.3 | 3.3 | 18.8 |
| Sample 12 | | | | | | | | |
| Comparative | TiCNO | 0.3 | TiCN | 7.0 | — | — | 7.3 | 22.8 |
| Sample 13 | | | | | | | | |
| Comparative | TiCNO | 0.3 | TiCN | 3.0 | TiN | 0.3 | 3.6 | 8.1 |
| Sample 14 | | | | | | | | |
| Comparative | TiCNO | 0.3 | TiCN | 3.0 | TiN | 0.3 | 3.6 | 33.6 |
| Sample 15 | | | | | | | | |

* “—” in this table indicates that the corresponding layer was not formed.

### RSA and RSB

The RSA and the RSB were calculated as follows.

In the obtained samples, the cross section of the TiCN layer of the upper layer was exposed in a direction parallel to the surface of the substrate, in a position where 80% of the average thickness of the TiCN layer in the upper layer remained from the substrate side. The obtained cross section was subjected to mirror polishing, and the mirror polished surface was observed by a field emission type scanning electron microscope (FE-SEM). By using an electron backscatter diffraction pattern apparatus (EBSD) incorporated in FE-SEM, the misorientation A formed by a normal to the exposed cross section and a normal to a (422) plane of each grain of the TiCN layer was measured. The ratio of the cross-sectional area of the region where the misorientation A is 0 degrees or more and less than 15 degrees to the sum of the cross-sectional areas of the TiCN layer of the upper layer analyzed (the sum of the cross-sectional areas of the TiCN layer of the upper layer having a misorientation A in the range of 0 degrees or more and 45 degrees or less: RSA_{Total}) of 100 area % was taken as RSA (unit: area %). Specifically, the cross-sectional areas of regions having a misorientation A in the range of 0 degrees or more and less than 15 degrees, and the cross-sectional areas of regions having a misorientation A in the range of 0 degrees or more and 45 degrees or less were determined. It should be noted that the sum of the cross-sectional areas of regions with 0 degrees or more and 45 degrees or less was taken as 100 area %. A ratio of the sum of the cross-sectional areas of regions having a misorientation A in the range of 0 degrees or more and less than 15 degrees among these cross-sectional areas based on the misorientation A to RSA_{Total} was taken as RSA. By using an EBSD incorporated in FE-SEM, the misorientation B formed by a normal to the exposed cross section and a normal to a (220) plane of each grain of the TiCN layer was measured in the same manner. The ratio of the cross-sectional area of the region where the misorientation B is 0 degrees or more and less than 15 degrees to the sum of the cross-sectional areas of the TiCN layer of the upper layer analyzed (the sum of the cross-sectional areas of the TiCN layer of the upper layer having a misorientation B in the range of 0 degrees or more and 45 degrees or less: RSB_{Total}) of 100 area % was taken as RSB (unit: area %). Specifically, the cross-sectional areas of regions having a misorientation B in the range of 0 degrees or more and less than 15 degrees, and the cross-sectional areas of regions having a misorientation B in the range of 0 degrees or more and 45 degrees or less were determined. It should be noted that the sum of the cross-sectional areas of the regions with 0 degrees or more and 45 degrees or less was taken as 100 area %. A ratio of the sum of the cross-sectional areas of regions having a misorientation B in the range of 0 degrees or more and less than 15 degrees among these cross-sectional areas based on the misorientation B to RSB_{Total} was taken as RSB. The above measurement results are shown in the following Table 8. The measurement by EBSD was performed as follows. The sample was set in the FE-SEM. The sample was irradiated with an electron beam with an acceleration voltage of 15 kV and an irradiation current of 1.0 nA at an incident angle of 70 degrees. In the measurement range of 120 μm×120 μm, the misorientation and cross-sectional area of each grain were measured by setting the EBSD to a step size (distance between measurement points) of 0.05 μm. The cross-sectional area of the TiCN layer of the upper layer within the measurement range was taken as the total of pixels corresponding to the area. That is, the sum of the cross-sectional areas of each region based on the misorientations A and B was determined by summing up the pixels occupied by the cross section of the region corresponding to the range of each misorientation and converting the sum to the area. The same measurement by EBSD was performed in the above measurement range at three fields of view in total, and the average values of the obtained areas were determined. The RSA and the RSB were calculated from the obtained average values.

### Average Diameter of Each Region

As to the average diameter of the region A, an equivalent circle diameter was determined for each region, and the area average value of the resulting measurements was determined as “the average diameter of the region A”. Specifically, the average diameter of the region A was determined by the following method. In the measurement range of 120 μm×120 μm, the measurement by EBSD was performed at three fields of view in total by setting the EBSD to a step size (distance between measurement points) of 0.05 μm. The region where the misorientation A is 0 degrees or more and less than 15 degrees surrounded by a boundary between measurement points where the misorientation A is 0 degrees or more and less than 15 degrees and other measurement points was defined as a region A, and the cross-sectional area occupied by each region A was determined. The diameter of a circle having an area equal to the obtained cross-sectional area was taken as the diameter of each region A. The mean area diameter of the diameters of the regions A included in the measurement range was taken as the average diameter of the region A.

The method for measuring “the average diameter of the region B” was the same as the method for measuring the average diameter of the region A, except that the specified boundary was “a boundary between measurement points where the misorientation B is 0 degrees or more and less than 15 degrees and other measurement points” and the specified region was “the region where the misorientation B is 0 degrees or more and less than 15 degrees”. The results are shown in Table 8 below.

### Average Grain Diameter of Grains of TiCN Layer

As to the average grain diameter of grains of the TiCN layer, an equivalent circle diameter was determined for each grain, and the area average value of the resulting measurements was determined as the average grain diameter. Specifically, the average grain diameter of grains of the TiCN layer was calculated as follows. In the measurement range of 120 μm×120 μm, the measurement by EBSD was performed at three fields of view in total by setting the EBSD to a step size (distance between measurement points) of 0.05 μm. In this case, the boundary between measurement points having a misorientation of 5° or more was taken as the grain boundary. The region surrounded by the grain boundary was defined as a grain, and the cross-sectional area occupied by each grain was determined. The diameter of a circle having an area equal to the obtained cross-sectional area was taken as the grain diameter of each grain. The mean area diameter of grain diameters of all the grains included in the measurement range was taken as the average grain diameter of grains of the TiCN layer. The results are shown in Table 8 below.

TABLE 8

| | Upper layer | | | | |
|---|---|---|---|---|---|
| | TiCN layer | | | | |
| | | | Average | Average | |
| | | | diameter | diameter | Average |
| | | | of region | of region | grain |
| Sample | RSA | RSB | A | B | diameter |
| Number | (area %) | (area %) | (μm) | (μm) | (μm) |
| Invention | 52 | 35 | 2.5 | 8.2 | 0.7 |
| Sample 1 | | | | | |
| Invention | 53 | 35 | 1.6 | 8.1 | 0.7 |
| Sample 2 | | | | | |
| Invention | 52 | 35 | 3.7 | 8.0 | 0.7 |
| Sample 3 | | | | | |
| Invention | 51 | 35 | 4.8 | 7.8 | 0.7 |
| Sample 4 | | | | | |
| Invention | 32 | 34 | 2.5 | 5.3 | 0.7 |
| Sample 5 | | | | | |
| Invention | 68 | 24 | 1.7 | 14.2 | 0.7 |
| Sample 6 | | | | | |
| Invention | 50 | 22 | 1.5 | 8.0 | 0.7 |
| Sample 7 | | | | | |
| Invention | 33 | 56 | 2.2 | 6.2 | 0.5 |
| Sample 8 | | | | | |
| Invention | 33 | 58 | 4.7 | 8.2 | 0.7 |
| Sample 9 | | | | | |
| Invention | 53 | 35 | 1.1 | 4.6 | 0.3 |
| Sample 10 | | | | | |
| Invention | 52 | 35 | 1.6 | 6.0 | 0.5 |
| Sample 11 | | | | | |
| Invention | 53 | 35 | 4.2 | 12.5 | 1.1 |
| Sample 12 | | | | | |
| Invention | 64 | 24 | 4.6 | 27.5 | 1.2 |
| Sample 13 | | | | | |
| Invention | 52 | 35 | 4.4 | 18.6 | 1.5 |
| Sample 14 | | | | | |
| Invention | 51 | 36 | 2.5 | 8.2 | 0.7 |
| Sample 15 | | | | | |
| Invention | 52 | 34 | 2.5 | 8.2 | 0.7 |
| Sample 16 | | | | | |
| Invention | 56 | 35 | 2.4 | 9.0 | 0.7 |
| Sample 17 | | | | | |
| Invention | 48 | 36 | 2.6 | 7.2 | 0.7 |
| Sample 18 | | | | | |
| Invention | 42 | 34 | 2.5 | 6.0 | 0.7 |
| Sample 19 | | | | | |
| Invention | 60 | 29 | 2.6 | 12.5 | 0.8 |
| Sample 20 | | | | | |
| Invention | 62 | 30 | 2.9 | 15.5 | 0.9 |
| Sample 21 | | | | | |
| Invention | 40 | 33 | 2.8 | 7.8 | 0.7 |
| Sample 22 | | | | | |
| Invention | 52 | 26 | 2.4 | 9.4 | 0.7 |
| Sample 23 | | | | | |
| Invention | 52 | 42 | 3.6 | 9.3 | 0.7 |
| Sample 24 | | | | | |
| Invention | 48 | 42 | 3.0 | 7.8 | 0.8 |
| Sample 25 | | | | | |
| Invention | 59 | 28 | 2.4 | 10.2 | 0.7 |
| Sample 26 | | | | | |
| Comparative | 24 | 36 | 2.6 | 4.5 | 0.7 |
| Sample 1 | | | | | |
| Comparative | 25 | 35 | 7.0 | 7.8 | 1.4 |
| Sample 2 | | | | | |
| Comparative | 25 | 35 | 4.6 | 6.4 | 1.1 |
| Sample 3 | | | | | |
| Comparative | 73 | 17 | 2.5 | 10.2 | 0.7 |
| Sample 4 | | | | | |
| Comparative | 26 | 15 | 0.9 | 5.2 | 0.7 |
| Sample 5 | | | | | |
| Comparative | 24 | 16 | 2.4 | 10.4 | 1.2 |
| Sample 6 | | | | | |
| Comparative | 26 | 64 | 6.1 | 8.2 | 0.7 |
| Sample 7 | | | | | |
| Comparative | 26 | 65 | 2.1 | 4.0 | 0.3 |
| Sample 8 | | | | | |
| Comparative | 28 | 62 | 2.2 | 5.2 | 0.3 |
| Sample 9 | | | | | |
| Comparative | 52 | 35 | 7.2 | 18.6 | 1.7 |
| Sample 10 | | | | | |
| Comparative | 52 | 35 | 6.8 | 8.2 | 0.7 |
| Sample 11 | | | | | |
| Comparative | 18 | 12 | 2.3 | 2.4 | 0.7 |
| Sample 12 | | | | | |
| Comparative | 52 | 35 | 2.5 | 8.2 | 0.7 |
| Sample 13 | | | | | |
| Comparative | 36 | 33 | 2.6 | 5.3 | 0.7 |
| Sample 14 | | | | | |
| Comparative | 64 | 22 | 2.3 | 14.5 | 0.9 |
| Sample 15 | | | | | |

Texture coefficient TC(0,0,12) of (0,0,12) plane of α-Al₂O₃ layer

For the obtained samples, X-ray diffraction measurement with a 2θ/θ focused optical system using Cu-Kα rays was performed under the conditions of output: 45 kV, 200 mA, incident side solar slit: 5°, divergent vertical slit: 2/3°, divergent vertical limiting slit: 5 mm, scattering slit: 8 mm, light receiving side solar slit: 5°, light receiving slit: 10 mm, detector: D/tex ultra, scan mode: continuous, sampling width: 0.01°, scan speed: 12°/min, and 20 measurement range: 25° to 140°. The apparatus used was an X-ray diffractometer manufactured by Rigaku Corporation (model “SmartLab”). The peak intensity of each crystal plane of the α-Al₂O₃ layer in the intermediate layer was determined from the X-ray diffraction pattern. The texture coefficient TC(0,0,12) of the (0,0,12) plane of the α-Al₂O₃ layer is represented by the following expression (iii) was determined based on the obtained peak intensity of each crystal plane. The results are shown in Table 9.

$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$

wherein I(h,k,l) is a peak intensity by X-ray diffraction obtained by measuring a (h,k,l) plane of the α-Al₂O₃ layer, I₀ (h,k,l) is a standard diffraction intensity of the (h,k,l) plane of α-Al₂O₃ obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12).

TABLE 9

| | Coating layer |
|---|---|
| Sample | Intermediate layer |
| Number | TC(0, 0, 12) |
| Invention Sample 1 | 7.2 |
| Invention Sample 2 | 7.2 |
| Invention Sample 3 | 7.2 |
| Invention Sample 4 | 7.2 |
| Invention Sample 5 | 5.3 |
| Invention Sample 6 | 8.4 |
| Invention Sample 7 | 7.2 |
| Invention Sample 8 | 7.2 |
| Invention Sample 9 | 7.2 |
| Invention Sample 10 | 7.2 |
| Invention Sample 11 | 7.2 |
| Invention Sample 12 | 7.2 |
| Invention Sample 13 | 8.8 |
| Invention Sample 14 | 7.2 |
| Invention Sample 15 | 7.2 |
| Invention Sample 16 | 7.2 |
| Invention Sample 17 | 7.5 |
| Invention Sample 18 | 6.8 |
| Invention Sample 19 | 6.3 |
| Invention Sample 20 | 8.0 |
| Invention Sample 21 | 8.4 |
| Invention Sample 22 | 6.5 |
| Invention Sample 23 | 7.2 |
| Invention Sample 24 | 7.2 |
| Invention Sample 25 | 7.2 |
| Invention Sample 26 | 7.7 |
| Comparative Sample 1 | 4.6 |
| Comparative Sample 2 | 4.7 |
| Comparative Sample 3 | 4.7 |
| Comparative Sample 4 | 8.8 |
| Comparative Sample 5 | 7.2 |
| Comparative Sample 6 | 7.2 |
| Comparative Sample 7 | 7.2 |
| Comparative Sample 8 | 7.2 |
| Comparative Sample 9 | 8.2 |
| Comparative Sample 10 | 7.2 |
| Comparative Sample 11 | 7.2 |
| Comparative Sample 12 | 7.2 |
| Comparative Sample 13 | 7.2 |
| Comparative Sample 14 | 5.6 |
| Comparative Sample 15 | 8.3 |

Cutting tests 1 and 2 were conducted using the obtained samples, i.e., Invention Samples 1 to 26 and Comparative Samples 1 to 15, under the following conditions. Cutting test 1 is a test for evaluating wear resistance and chipping resistance, and cutting test 2 is a test for evaluating fracture resistance. The results of the respective cutting tests are shown in Table 10.

[Cutting test 1]
Workpiece material: SCM415,
Workpiece material shape: round bar with two grooves at an equal distance on the outer peripheral surface,
Cutting speed: 240 m/min,
Depth of cut: 1.5 mm,
Feed: 0.20 mm/rev,
Coolant: water-soluble coolant,
Evaluation item: the time at which the sample was fractured or the maximum flank wear width reached 0.3 mm was defined as the tool life, and the machining time to reach the end of the tool life was measured. The damage form after machining for 10 minutes was observed by SEM.

### [Cutting Test 2]

Workpiece material: S45C,
Workpiece material shape: round bar with four grooves at an equal distance on the outer peripheral surface,
Cutting speed: 180 m/min,
Depth of cut: 1.5 mm,
Feed: 0.25 mm/rev,
Coolant: water-soluble coolant,
Evaluation item: the time at which the sample was fractured was defined as the tool life, and the number of shocks to reach the end of the tool life was measured.

As to the machining time to reach the end of the tool life in cutting test 1, evaluations were made with grade “A” for 37 minutes or more, grade “B” for 25 minutes or more and less than 37 minutes, and “C” for less than 25 minutes. As to the cumulative number of shocks to reach the end of the tool life in cutting test 2, evaluations were made with grade “A” for 15,000 shocks or more, grade “B” for 10,000 shocks or more and less than 15,000 shocks, and grade “C” for less than 10,000. In such evaluations, “A” refers to excellent, “B” refers to good and “C” refers to inferior, meaning that a sample involving a larger number of “A”s or “B”s has more excellent cutting performance. The evaluation results are shown in Table 10. It should be noted that, Comparative Sample 15 was fractured before the end of machining for 10 minutes, and is therefore set forth as “−”

TABLE 10

| | Cutting test 1 | | | Cutting test 2 | |
|---|---|---|---|---|---|
| | Damage | | | Tool | |
| | form after | | | life | |
| | machining | Tool | | (number | |
| Sample | for 10 | life | | of | |
| Number | minutes | (minutes) | Evaluation | shocks) | Evaluation |
| Invention | Normal | 36 | B | 13500 | B |
| Sample 1 | wear | | | | |
| Invention | Normal | 37 | A | 15000 | A |
| Sample 2 | wear | | | | |
| Invention | Normal | 33 | B | 13000 | B |
| Sample 3 | wear | | | | |
| Invention | Normal | 31 | B | 12500 | B |
| Sample 4 | wear | | | | |
| Invention | Normal | 29 | B | 13500 | B |
| Sample 5 | wear | | | | |
| Invention | Normal | 45 | A | 12500 | B |
| Sample 6 | wear | | | | |
| Invention | Normal | 37 | A | 13000 | B |
| Sample 7 | wear | | | | |
| Invention | Normal | 29 | B | 18000 | A |
| Sample 8 | wear | | | | |
| Invention | Normal | 27 | B | 16000 | A |
| Sample 9 | wear | | | | |
| Invention | Normal | 28 | B | 14000 | B |
| Sample 10 | wear | | | | |
| Invention | Normal | 33 | B | 14500 | B |
| Sample 11 | wear | | | | |
| Invention | Normal | 35 | B | 12500 | B |
| Sample 12 | wear | | | | |
| Invention | Normal | 42 | A | 11000 | B |
| Sample 13 | wear | | | | |
| Invention | Normal | 38 | A | 11500 | B |
| Sample 14 | wear | | | | |
| Invention | Normal | 33 | B | 12500 | B |
| Sample 15 | wear | | | | |
| Invention | Normal | 34 | B | 12000 | B |
| Sample 16 | wear | | | | |
| Invention | Normal | 36 | B | 13500 | B |
| Sample 17 | wear | | | | |
| Invention | Normal | 35 | B | 12500 | B |
| Sample 18 | wear | | | | |
| Invention | Normal | 26 | B | 17000 | A |
| Sample 19 | wear | | | | |
| Invention | Normal | 42 | A | 10500 | B |
| Sample 20 | wear | | | | |
| Invention | Normal | 41 | A | 12000 | B |
| Sample 21 | wear | | | | |
| Invention | Normal | 32 | B | 12500 | B |
| Sample 22 | wear | | | | |
| Invention | Normal | 34 | B | 13000 | B |
| Sample 23 | wear | | | | |
| Invention | Normal | 38 | A | 12000 | B |
| Sample 24 | wear | | | | |
| Invention | Normal | 29 | B | 16500 | A |
| Sample 25 | wear | | | | |
| Invention | Normal | 41 | A | 11000 | B |
| Sample 26 | wear | | | | |
| Comparative | Normal | 21 | C | 12500 | B |
| Sample 1 | wear | | | | |
| Comparative | Chipping | 13 | C | 10500 | B |
| Sample 2 | | | | | |
| Comparative | Normal | 22 | C | 11000 | B |
| Sample 3 | wear | | | | |
| Comparative | Chipping | 14 | C | 6500 | C |
| Sample 4 | | | | | |
| Comparative | Chipping | 13 | C | 6000 | C |
| Sample 5 | | | | | |
| Comparative | Chipping | 14 | C | 7000 | C |
| Sample 6 | | | | | |
| Comparative | Chipping | 17 | C | 12500 | B |
| Sample 7 | | | | | |
| Comparative | Normal | 20 | C | 14500 | B |
| Sample 8 | wear | | | | |
| Comparative | Normal | 23 | C | 14000 | B |
| Sample 9 | wear | | | | |
| Comparative | Chipping | 13 | C | 9000 | C |
| Sample 10 | | | | | |
| Comparative | Chipping | 13 | C | 9500 | C |
| Sample 11 | | | | | |
| Comparative | Chipping | 11 | C | 5500 | C |
| Sample 12 | | | | | |
| Comparative | Chipping | 18 | C | 7500 | C |
| Sample 13 | | | | | |
| Comparative | Normal | 20 | C | 16500 | A |
| Sample 14 | wear | | | | |
| Comparative | — | 8 | C | 5000 | C |
| Sample 15 | | | | | |

The results in Table 10 show that each invention sample had grade “A” or “B” in both cutting test 1 and cutting test 2. Meanwhile, as to the evaluations made on the comparative samples, each comparative sample had grade “C” in either or both of the chipping test and the wear test. Accordingly, it is apparent that the wear resistance, the chipping resistance and the fracture resistance of each invention sample are more excellent than that of each comparative sample.

It is apparent from the above results that each invention sample has excellent wear resistance, chipping resistance and fracture resistance, thereby resulting in a longer tool life.

### INDUSTRIAL APPLICABILITY

The coated cutting tool according to the present invention has excellent wear resistance, chipping resistance and fracture resistance, so that the tool life can be extended more than that involved in the prior art, and from such perspective, the coated cutting tool has industrial applicability.

### REFERENCE SIGNS LIST

1: Substrate, 2: Lower layer, 3: Intermediate layer, 4: Upper layer, 5: Coating layer, 6: Coated cutting tool.

What is claimed is:

1. A coated cutting tool comprising a substrate and a coating layer formed on a surface of the substrate, wherein:
the coating layer comprises a lower layer, an intermediate layer, and an upper layer in this order from the substrate side to the surface side of the coating layer;
the lower layer comprises a Ti compound layer containing a Ti compound of Ti and an element of at least one kind selected from the group consisting of C, N, O and B;
the intermediate layer comprises an α-Al₂O₃ layer containing α-aluminum oxide;
the upper layer comprises a TiCN layer containing a Ti carbonitride;
an average thickness of the entire coating layer is 8.5 μm or more and 30.0 μm or less;
an average thickness of the upper layer is 1.0 μm or more and 6.0 μm or less;
the TiCN layer of the upper layer satisfies conditions represented by following formula (i) and formula (ii):
$$30 \leq RSA \leq 70 \qquad ( i )$$
in the formula (i), where, in a cross section of the TiCN layer of the upper layer in a direction parallel to the surface of the substrate, a sum of areas of an entire cross section is taken as 100 area %, RSA is a ratio, in terms of area %, of a sum of cross-sectional areas of regions A where a misorientation A is 0 degrees or more and less than 15 degrees, the misorientation A being an angle, in terms of degrees, formed by a normal to the cross section of the TiCN layer and a normal to a (422) plane of grains of the TiCN layer;
$$20 \leq RSB \leq 60 \qquad ( ii )$$
in the formula (ii), where, in a cross section of the TiCN layer of the upper layer in a direction parallel to the surface of the substrate, a sum of areas of an entire cross section is taken as 100 area %, RSB is a ratio, in terms of area %, of a sum of cross-sectional areas of regions B where a misorientation B is 0 degrees or more and less than 15 degrees, the misorientation B being an angle, in terms of degrees, formed by a normal to the cross section of the TiCN layer and a normal to a (220) plane of grains of the TiCN layer; and
an average diameter of the region B is less than 5.0 μm in the TiCN layer of the upper layer.

2. The coated cutting tool according to claim 1, wherein the average diameter of the region B is 1.0 μm or more in the TiCN layer of the upper layer.

3. The coated cutting tool according to claim 1, wherein an average diameter of the region A is 5.0 μm or more and 30.0 μm or less in the TiCN layer of the upper layer.

4. The coated cutting tool according to claim 1, wherein an average grain diameter of grains is 0.3 μm or more and 1.2 μm or less in the TiCN layer of the upper layer.

5. The coated cutting tool according to claim 1, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

6. The coated cutting tool according to claim 1, wherein an average thickness of the intermediate layer is 3.0 μm or more and 15.0 μm or less.

7. The coated cutting tool according to claim 1, wherein an average thickness of the lower layer is 3.0 μm or more and 15.0 μm or less.

8. The coated cutting tool according to claim 1, wherein the substrate is any one of a cemented carbide, cermet, ceramic or a cubic boron nitride sintered body.

9. The coated cutting tool according to claim 2, wherein an average diameter of the region A is 5.0 μm or more and 30.0 μm or less in the TiCN layer of the upper layer.

10. The coated cutting tool according to claim 2, wherein an average grain diameter of grains is 0.3 μm or more and 1.2 μm or less in the TiCN layer of the upper layer.

11. The coated cutting tool according to claim 3, wherein an average grain diameter of grains is 0.3 μm or more and 1.2 μm or less in the TiCN layer of the upper layer.

12. The coated cutting tool according to claim 9, wherein an average grain diameter of grains is 0.3 μm or more and 1.2 μm or less in the TiCN layer of the upper layer.

13. The coated cutting tool according to claim 2, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

14. The coated cutting tool according to claim 3, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

15. The coated cutting tool according to claim 4, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

16. The coated cutting tool according to claim 9, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

17. The coated cutting tool according to claim 10, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀(h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

18. The coated cutting tool according to claim 11, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

19. The coated cutting tool according to claim 12, wherein a texture coefficient TC(0,0,12) of a (0,0,12) plane of the α-Al₂O₃ layer represented by a following formula (iii):
$$TC ( 0 , 0 , 12 ) = \frac{I ( 0 , 0 , 12 )}{{I}_{0} ( 0 , 0 , 12 )} {\{ \frac{1}{9} \sum \frac{I ( h , k , l )}{{I}_{0} ( h , k , l )} \}}^{- 1} \qquad ( iii )$$
wherein I(h,k,l) is a peak intensity by X-ray diffraction obtained by measuring a (h,k,l) plane of the α-Al₂O₃ layer contained in the intermediate layer, I₀ (h,k,l) is a standard diffraction intensity of the (h,k,l) plane of α-aluminum oxide obtained from JCPDS card number 10-0173, and (h,k,l) refers to 9 crystal planes of (0,1,2), (1,0,4), (1,1,3), (0,2,4), (1,1,6), (2,1,4), (3,0,0), (0,2,10), and (0,0,12), is 5.0 or more and 8.9 or less in the intermediate layer.

20. The coated cutting tool according to claim 2, wherein an average thickness of the intermediate layer is 3.0 μm or more and 15.0 μm or less.
